(19) United States
(12) Patent Application Publication
(10) Pub. No.: US 2023/0153849 A1
(43) Pub. Date: May 18, 2023

(54) INFORMATION PROCESSING APPARATUS, INFORMATION PROCESSING METHOD, AND INFORMATION PROCESSING PROGRAM

(71) Applicant: SONY GROUP CORPORATION, TOKYO (JP)

(72) Inventors: MASATSUGU ISHIKO, TOKYO (JP); TSUTOMU NAKATSURU, TOKYO (JP); MASATO KITA, TOKYO (JP)

(21) Appl. No.: 17/905,891

(22) PCT Filed: Mar. 10, 2021
(86) PCT No.: PCT/JP2021/009433

§ 371 Date: Sep. 8, 2022

(30) Foreign Application Priority Data
Mar. 19, 2020 (JP) 2020-048968

(51) Int. Cl. G06Q 30/0204; G06T 11/20; G01P 13/00

(52) U.S. Cl. CPC G06Q 30/0205; G06T 11/203; G01P 13/00

(57) ABSTRACT

To provide an information processing apparatus, an information processing method, and an information processing program capable of analyzing the motion of a person in more detail. An information processing apparatus includes an acquisition unit (200) that acquires at least a position and an orientation of a moving body, and an analysis unit (202) that generates a label indicating a motion of the moving body on the basis of the position and the orientation acquired by the acquisition unit and time when the acquisition unit acquired the position and the orientation.

### TECHNICAL FIELD

The present disclosure relates to an information processing apparatus, an information processing method, and an information processing program.

### BACKGROUND ART

Conventionally, a technique for detecting, analyzing, and visualizing a movement trajectory of a person in a limited region such as in a store has been developed. For example, by detecting, analyzing, and visualizing movement trajectories of customers, sales persons, and the like in a store, flow lines, product arrangement, and the like can be easily managed, and efficient store operation can be performed.

### CITATION LIST

### Patent Document

Patent Document 1: Japanese Patent Application Laid-Open No. 2018-120344
Patent Document 2: Japanese Patent Application Laid-Open No. 2018-128895

### SUMMARY OF THE INVENTION

### Problems to be Solved by the Invention

However, conventionally, even if the movement trajectory of a person can be visualized, it is difficult to specify the motion of the person. For example, in a case where a monitoring camera is used, the motion of the person can be easily grasped by the image. However, in an example in which the monitoring camera is used, in a case where persons overlap each other in the image, it is difficult to confirm the motion of the person on the far side with respect to the camera among the overlapping persons. As described above, in the example in which the monitoring camera is used, for example, in a situation where there is a large number of people in a limited region, it is difficult to grasp the motions of the people.

An object of the present disclosure is to provide an information processing apparatus, an information processing method, and an information processing program capable of analyzing the motion of a person in more detail.

### Solutions to Problems

An information processing apparatus according to the present disclosure includes an acquisition unit that acquires at least a position and an orientation of a moving body, and an analysis unit that generates a label indicating a motion of the moving body on the basis of the position and the orientation acquired by the acquisition unit and time when the acquisition unit acquired the position and the orientation.

### BRIEF DESCRIPTION OF DRAWINGS

FIG. 1 is a functional block diagram of an example for describing a function of an information processing system according to an embodiment of the present disclosure.

FIG. 2 is a block diagram illustrating a configuration of an example of an information processing system applicable to the embodiment.

FIG. 3 is a block diagram illustrating a configuration of an example of an analysis server applicable to the embodiment.

FIG. 4 is a block diagram illustrating a configuration of an example of a terminal apparatus on which a moving body positioning apparatus is mounted applicable to the embodiment.

FIG. 5 is a schematic diagram illustrating an example of a store map applicable to the embodiment.

FIG. 6 is a schematic diagram illustrating a format example of region map information applicable to the embodiment.

FIG. 7 is a schematic diagram illustrating a specific example of region map information according to the embodiment.

FIG. 8 is a schematic diagram illustrating an example of an area defined for an analysis target object, which is applicable to the embodiment.

FIG. 9 is a schematic diagram illustrating a format example of analysis target object information defining an area, which is applicable to the embodiment.

FIG. 10 is a schematic diagram illustrating a specific example of analysis target object information according to the embodiment.

FIG. 11 is a schematic diagram for describing motions defined in the embodiment.

FIG. 12 is a schematic diagram illustrating an example of region division for determining a direction of an object according to the embodiment.

FIG. 13 is a schematic diagram illustrating an example of a case where each divided angle range is different for each area.

FIG. 14 is a schematic diagram illustrating local coordinates set for an area.

FIG. 15 is a schematic diagram illustrating a format example of an analysis rule applicable to the embodiment.

FIG. 16 is a schematic diagram illustrating an example of a trajectory of a motion of a moving body.

FIG. 17 is a schematic diagram illustrating a specific example of analysis rule information according to the embodiment.

FIG. 18 is a schematic diagram illustrating a specific description example of analysis rule information according to the embodiment.

FIG. 19 is a flowchart of an example illustrating a method of analyzing sampling data based on analysis rule information according to the embodiment.

FIG. 20 is a schematic diagram illustrating an example of an analysis result by motion analysis according to the embodiment.

FIG. 21 is a flowchart of an example illustrating drawing information creation processing according to the embodiment.

FIG. 22 is a diagram schematically illustrating an example of display by visualization information created by a drawing information creation unit according to the embodiment.

FIG. 23 is a schematic diagram illustrating an example in which a visualization expression based on an analysis result according to the embodiment is applied to a trajectory of a moving body.

FIG. 24 is a schematic diagram illustrating an example of a second visualization expression applicable to the embodiment.

FIG. 25 is a schematic diagram illustrating an example of a third visualization expression applicable to the embodiment.

FIG. 26 is a schematic diagram illustrating an example of a fourth visualization expression applicable to the embodiment.

FIG. 27 is a schematic diagram illustrating an example of a fifth visualization expression applicable to the embodiment.

FIG. 28 is a schematic diagram illustrating an example of a sixth visualization expression applicable to the embodiment.

FIG. 29 is a schematic diagram illustrating an example of a seventh visualization expression applicable to the embodiment.

FIG. 30 is a schematic diagram illustrating an example of an eighth visualization expression applicable to the embodiment.

FIG. 31 is a schematic diagram illustrating an example of a ninth visualization expression applicable to the embodiment.

FIG. 32 is a schematic diagram illustrating an example of a tenth visualization expression applicable to the embodiment.

FIG. 33 is a block diagram illustrating a configuration example of an information processing system according to a first modification of the embodiment.

FIG. 34 is a block diagram illustrating a configuration example of an information processing system according to a second modification of the embodiment.

### MODE FOR CARRYING OUT THE INVENTION

An embodiment of the present disclosure will be described in detail below on the basis of the drawings. Note that in the embodiment below, the same parts are designated by the same reference numerals and duplicate description will be omitted.

The embodiment of the present disclosure will be described below in the following order.

1. Configuration according to the embodiment

1-1. Regarding function of the information processing system according to the embodiment

1-2. Regarding configuration example of the information processing system applicable to the embodiment

1-2-1. Configuration example of system

1-2-2. Configuration example of server apparatus

1-2-3. Configuration example of terminal apparatus

2. Example of motion analysis according to the embodiment

2-1. Example of input information according to the embodiment

2-2. Motion detection example according to the embodiment

2-3. Motion analysis example according to the embodiment

3. Example of visualization expression of motion according to the embodiment

3-1. Other visualization expression examples

4. First modification of the embodiment

5. Second modification of the embodiment

### 1. Configuration According to the Embodiment

A configuration of an information processing system according to the embodiment of the present disclosure will be described. The information processing system of the present disclosure detects and analyzes the motion of a moving body such as a person in a limited region such as a store, and visualizes an analysis result. At this time, the information processing system of the present disclosure detects not only the position of the moving body but also the orientation of the moving body, analyzes the motion of the moving body on the basis of the detected position and orientation and information indicating the time when the detection is performed, and generates a label indicating the motion.

Moreover, the information processing system of the present disclosure makes a visualization expression for visualizing a change in the position of a moving body different from a visualization expression for visualizing the orientation indicating a specific direction according to a label when visualizing the motion of the moving body. Therefore, it is possible to analyze the motion of a person in more detail.

(1-1. Regarding Function of the Information Processing System According to the Embodiment)

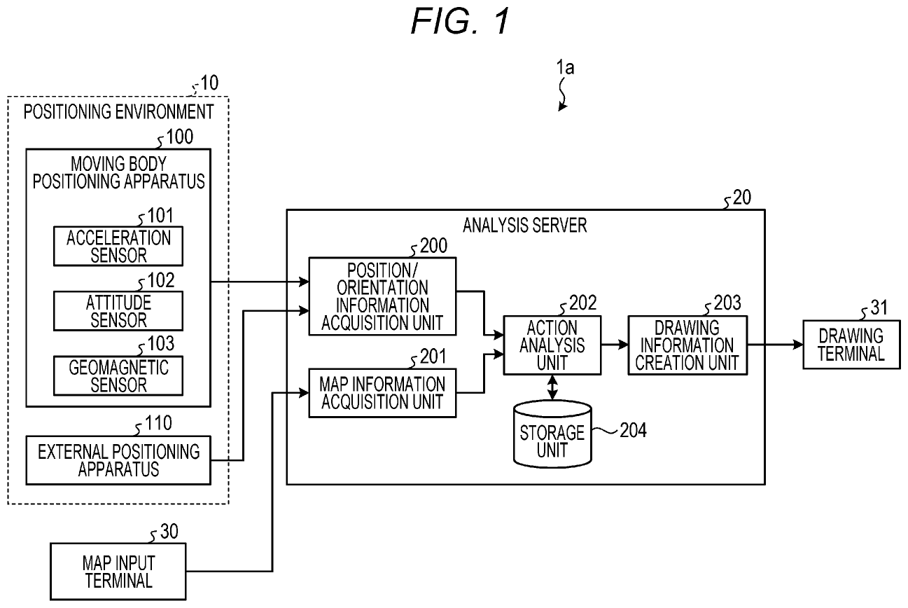

FIG. 1 is a functional block diagram of an example for describing a function of an information processing system according to the embodiment of the present disclosure. In FIG. 1, an information processing system 1a according to the embodiment includes positioning environment 10, an analysis server 20, a map input terminal 30, and a drawing terminal 31.

The positioning environment 10 is an environment for performing positioning of a moving body such as a target person, and includes at least one of a moving body positioning apparatus 100 associated with the moving body and an external positioning apparatus 110. The moving body positioning apparatus 100 can include an acceleration sensor 101, an attitude sensor 102, and a geomagnetic sensor 103, and detects the position and the orientation of a corresponding moving body.

The acceleration sensor 101 can detect, for example, acceleration in three axial directions of an X-axis, a Y-axis, and a Z-axis, and can calculate the velocity and the position of the moving body positioning apparatus 100 on the basis of a detection result. The attitude sensor 102 is, for example, a gyro sensor, and can calculate the direction in which the moving body positioning apparatus 100 faces on the basis of the detection result. The geomagnetic sensor 103 can calculate the direction in which the moving body positioning apparatus 100 faces by using geomagnetism.

The moving body positioning apparatus 100 does not need to include all of the acceleration sensor 101, the attitude sensor 102, and the geomagnetic sensor 103, and can detect the current position and direction of the moving body positioning apparatus 100 by including, for example, the acceleration sensor 101 and the attitude sensor 102. Since the moving body positioning apparatus 100 further includes the geomagnetic sensor 103, it is possible to correct the detected direction.

The moving body positioning apparatus 100 may be configured as a single piece of hardware, or may be used by being incorporated in advance in a mobile terminal apparatus such as a multifunctional mobile phone terminal (smartphone).

The external positioning apparatus 110 performs positioning of a moving body from the outside of the moving body, and for example, a beacon, which is a position-specifying technology using Bluetooth Low Energy (Bluetooth is a registered trademark), can be applied. It is not limited thereto, and a monitoring camera that performs positioning on the basis of an image may be applied as the external positioning apparatus 110. In this case, it is preferable to arrange a plurality of monitoring cameras that captures images from different directions in a positioning target region so as not to generate a blind spot. The external positioning apparatus 110 may use a plurality of positioning methods in combination.

Information of the position and orientation detected in the positioning environment 10 is transmitted to the analysis server 20. Here, in the positioning environment 10, the position and orientation are detected at a predetermined cycle, for example, at a cycle of several msecs to several seconds. The information of the position and orientation detected in the positioning environment 10 is transmitted from the positioning environment 10 to the analysis server 20 with time information indicating the time when the information is acquired being added. It is not limited thereto, and the position and orientation may be continuously detected in the positioning environment 10, and the information detected at a predetermined cycle may be transmitted to the analysis server 20. Furthermore, in the positioning environment 10, the information detected at a predetermined cycle may be accumulated, and the accumulated information may be transmitted to the analysis server 20 in response to a predetermined trigger.

Note that the configuration of the positioning environment 10 is not limited to the above-described configuration as long as positioning of a target moving body, that is, detection of the position and orientation at a predetermined cycle is possible.

As the map input terminal 30, for example, a general personal computer, smartphone, or tablet computer can be applied, and for example, map information is input according to a user operation. Although details will be described later, the map information includes region map information including coordinate information or the like in a positioning target region (for example, a store), information regarding an analysis target object, an analysis rule, and the like. The map information input to the map input terminal 30 is passed to the analysis server 20.

The analysis server 20 includes a position/orientation information acquisition unit 200, a map information acquisition unit 201, an action analysis unit 202, a drawing information creation unit 203, and a storage unit 204. The storage unit 204 includes a storage medium such as memory that stores data, and a read/write control unit that controls reading and writing of data from and to the storage medium.

The position/orientation information acquisition unit 200 acquires the position and orientation information transmitted from the positioning environment 10 and the time information (time stamp) indicating the time when the information is acquired, and aggregates the acquired position and orientation information and the time stamp in association with each other. Hereinafter, unless otherwise specified, the position and orientation information and the time stamp associated with the information will be collectively described as “sampling data”.

The map information acquisition unit 201 acquires the map information transmitted from the map input terminal 30. The map information is passed from the map information acquisition unit 201 to the action analysis unit 202 and stored in, for example, the storage unit 204.

The action analysis unit 202 analyzes the motion (action) of the target moving body on the basis of the sampling data aggregated by the position/orientation information acquisition unit 200 and the map information acquired by the map information acquisition unit 201 and stored in the storage unit 204. The action analysis unit 202 analyzes the motion according to the analysis rule included in the map information, and adds a label to the analyzed motion. The action analysis unit 202 passes the label added to the analyzed motion and the information indicating the analysis rule applied to the analysis to the drawing information creation unit 203.

The drawing information creation unit 203 creates visualization information for visualizing the motion of the target moving body on the basis of the label and the analysis rule passed from the action analysis unit 202. At this time, in a case where the label indicates the motion related to the orientation, the drawing information creation unit 203 creates the visualization information so that the direction indicated by the orientation becomes clear. The visualization information includes drawing information for generating a visualization expression visualizing such motion and orientation. Here, it is preferable that the drawing information creation unit 203 creates the visualization information on the basis of the drawing information in a format that can be drawn by a general web browser.

The visualization information created by the drawing information creation unit 203 is transmitted from the analysis server 20 to the drawing terminal 31. The drawing terminal 31 performs drawing on the basis of the visualization information transmitted from the analysis server 20 and generates an image. The drawing terminal 31 displays the generated image on a display device such as a liquid crystal display (LCD). As the drawing terminal 31, for example, a general personal computer, smartphone, or tablet computer can be applied.

(1-2. Regarding Configuration Example of the Information Processing System Applicable to the Embodiment)

(1-2-1. Configuration Example of System)

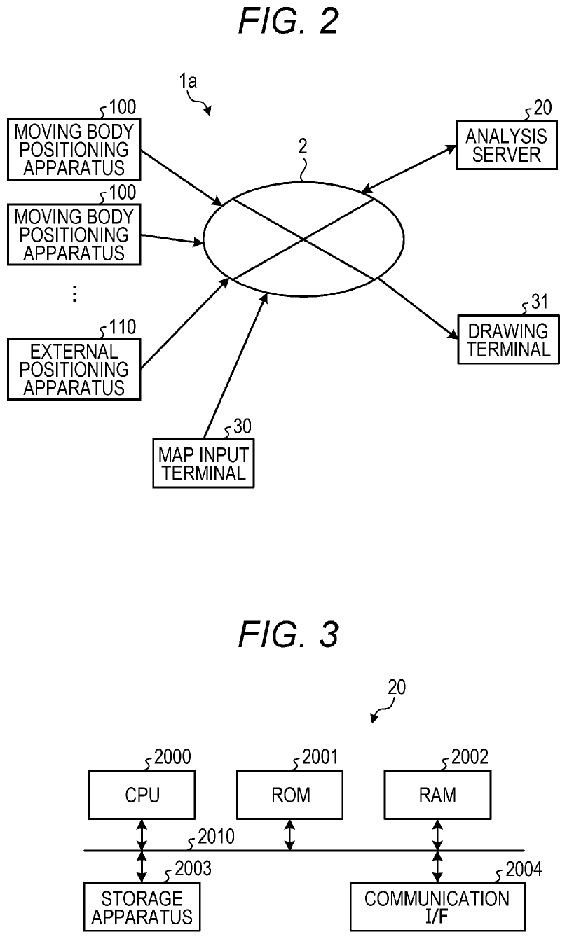

FIG. 2 is a block diagram illustrating a configuration of an example of an information processing system applicable to the embodiment. In FIG. 2, the information processing system 1a is configured by connecting each of the above-described moving body positioning apparatus 100, external positioning apparatus 110, analysis server 20, map input terminal 30, and drawing terminal 31 to a network 2 having a wire area such as the Internet. The information processing system 1a can include a plurality of moving body positioning apparatuses 100. Furthermore, the information processing system 1a can include a plurality of external positioning apparatuses 110. Moreover, although illustration is omitted, the information processing system 1a may include a plurality of map input terminals 30 and a plurality of drawing terminals 31, or may use the map input terminal 30 and the drawing terminal 31 as a common terminal apparatus.

The position and orientation information detected by each of the moving body positioning apparatuses 100 and each of the external positioning apparatuses 110, and the time information indicating the time when the information is acquired are transmitted to the analysis server 20 via the network 2. Similarly, the map information input by the map input terminal 30 is transmitted to the analysis server 20 via the network 2. The analysis server 20 receives these pieces of information via the network 2, analyzes the motion on the basis of the received information, and creates visualization information for realizing the visualization expression based on the analysis result. The analysis server 20 transmits the created visualization information to the drawing terminal 31 via the network 2. The drawing terminal 31 performs drawing on the basis of the visualization information received via the network 2, generates a display screen, and causes the display device to display the generated display screen.

Note that, in the above description, each piece of information detected by the moving body positioning apparatus 100 and the time information corresponding to the information are transmitted to the analysis server 20 via the network 2, but this is not limited to this example. For example, the information and the time information may be stored in a storage medium such as an SD memory card or universal serial bus (USB) memory and transferred to the analysis server 20. Furthermore, it is also conceivable that the moving body positioning apparatus 100 and the analysis server 20 are connected by an insertable and removable cable, and the information and the time information are transferred from the moving body positioning apparatus 100 to the analysis server 20 via the cable.

(1-2-2. Configuration Example of Server Apparatus)

FIG. 3 is a block diagram illustrating a configuration of an example of the analysis server 20 applicable to the embodiment. In FIG. 3, the analysis server 20 includes a central processing unit (CPU) 2000, read only memory (ROM) 2001, random access memory (RAM) 2002, a storage apparatus 2003, and a communication interface (I/F) 2004, which are communicably connected to each other via a bus 2010.

The storage apparatus 2003 includes one or more non-volatile storage media such as flash memory and a hard disk drive. The CPU 2000 operates using the RAM 2002 as work memory according to a program stored in advance in the ROM 2001 and the storage apparatus 2003, and controls the entire operation of the analysis server 20. The communication I/F 2004 controls communication with respect to the network 2 according to a command of the CPU 2000.

Note that the analysis server 20 can further include an input device that receives a user operation and a display device that presents information to the user.

The above-described position/orientation information acquisition unit 200, map information acquisition unit 201, action analysis unit 202, drawing information creation unit 203, and storage unit 204 (read/write control unit) are realized by, for example, an information processing program stored in advance in the storage apparatus 2003 operating on the CPU 2000. It is not limited thereto, and some or all of the position/orientation information acquisition unit 200, the map information acquisition unit 201, the action analysis unit 202, the drawing information creation unit 203, and the storage unit 204 (read/write control unit) may be configured by hardware circuits that cooperate with each other.

The information processing program is provided in a state of being stored in a predetermined storage medium, and is installed in the analysis server 20. It is not limited thereto, and the information processing program may be downloaded and installed in the analysis server 20 via the network 2.

The information processing program has a module configuration including, for example, the position/orientation information acquisition unit 200, the map information acquisition unit 201, the action analysis unit 202, the drawing information creation unit 203, and the storage unit 204 (read/write control unit). As actual hardware, when the CPU 2000 reads and executes the information processing program from a storage medium such as the storage apparatus 2003, for example, the above-described units are loaded onto a main storage apparatus such as the RAM 2002, and the units are generated on the main storage apparatus.

(1-2-3. Configuration Example of Terminal Apparatus)

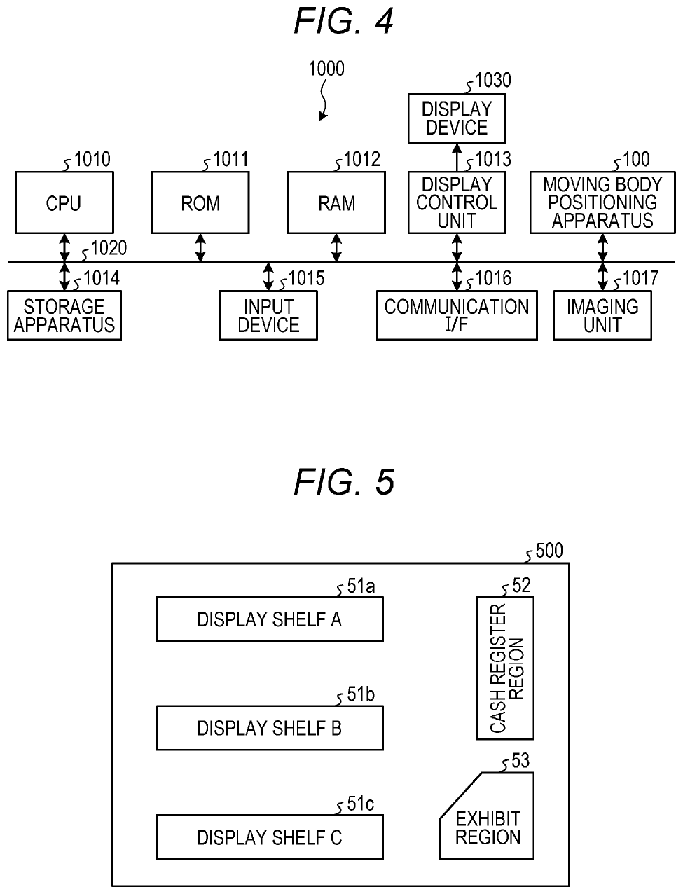

FIG. 4 is a block diagram illustrating a configuration of an example of a terminal apparatus on which the moving body positioning apparatus 100 is mounted applicable to the embodiment. Here, a smartphone is assumed as the terminal apparatus, and an acceleration sensor and a gyro sensor mounted on the smartphone are applied as the moving body positioning apparatus 100.

In FIG. 4, a terminal apparatus 1000 includes a CPU 1010, ROM 1011, RAM 1012, a display control unit 1013, a storage apparatus 1014, an input device 1015, a communication I/F 1016, and an imaging unit 1017, which are communicably connected to each other via a bus 1020, and the moving body positioning apparatus 100 is connected to the bus 1020. The storage apparatus 1014 is, for example, flash memory.

The CPU 1010 operates using the RAM 1012 as work memory according to a program stored in advance in the ROM 1011 and the storage apparatus 1014, and controls the entire operation of the terminal apparatus 1000. The display control unit 1013 is connected to a display device 1030 such as an LCD, generates a display signal in a format displayable by the display device 1030 on the basis of a display control signal generated by the CPU 1010, and supplies the display signal to the display device 1030.

The input device 1015 is, for example, a touch panel that is formed integrally with the display device 1030, transmits display by the display device 1030, and outputs a control signal corresponding to a touched position. It is not limited thereto, and the input device 1015 may further include an operator for receiving a user operation.

The communication I/F 1016 controls communication with respect to the network 2 via wireless communication according to a command of the CPU 1010. Furthermore, the communication I/F 1016 also controls communication via a public telephone line via wireless communication according to a command of the CPU 1010. The imaging unit 1017 captures an image according to a command of the CPU 1010, and outputs the captured image to the bus 1020.

The moving body positioning apparatus 100 detects the position and orientation of the terminal apparatus 1000 and passes the detection result to the CPU 1010 according to a command of the CPU 1010. For example, the CPU 1010 adds a time stamp to each piece of information passed from the moving body positioning apparatus 100, and passes the information to the communication I/F 1016. The communication I/F 1016 transmits each piece of information and the time stamp passed from the CPU 1010 to the network 2.

For example, the CPU 1010 controls the detection processing of the position and orientation by the moving body positioning apparatus 100 and the transmission of the detection result to the network 2 according to a program stored in the storage apparatus 1014. For example, the program is downloaded to the terminal apparatus 1000 via the network 2 or another network and installed in the terminal apparatus 1000. The program may be stored in a predetermined storage medium and installed in the terminal apparatus 1000.

### 2. Example of Motion Analysis According to the Embodiment

(2-1. Example of Input Information According to the Embodiment)

Next, an example of the motion analysis of the moving body in the analysis server 20 according to the embodiment will be described. First, map information input from the map input terminal 30 will be described. Note that, in the following description, it is assumed that a region to be analyzed for motion is a store, and a moving body to be analyzed for motion is a person. It is assumed that a person, which is a moving body, holds or wears the above-described moving body positioning apparatus 100 by a predetermined method.

First, the region map information included in the map information will be described.

FIG. 5 is a schematic diagram illustrating an example of a store map applicable to the embodiment. The store map includes an outer shape of the store and a specific region arranged within the outer shape of the store. In FIG. 5, an object 500 indicates the outer shape of the store and is an object always included in the store map. In the example of FIG. 5, five objects 51a, 51b, 51c, 52, and 53 are arranged inside the object 500 of the store. The objects 51a to 51c are respectively a display shelf A, a display shelf B, and a display shelf C on which products are displayed. The object 52 is a cash register region in which a cash register apparatus that transfers money is installed. Furthermore, the object 53 is an exhibit region in which an exhibit is exhibited.

Note that, in the example of FIG. 5, the object 500 of the store and the objects 51a, 51b, 51c, 52, and 53 are illustrated so as not to overlap each other, but this is not limited to this example, and a plurality of objects can be arranged so as to partially or entirely overlap each other.

Among them, the objects 51a to 51c are arranged in parallel with sides of the object 500, and it is assumed that a person confirms the display objects from the lower side in the longitudinal direction in the drawing. The object 52 is arranged in parallel with sides of the object 500, and it is assumed that a person lines up from the left side in the longitudinal direction in the drawing. Furthermore, it is assumed that the object 53 is obliquely cut out at the upper left corner in the drawing, and the exhibit is confirmed from the obliquely cut out side.

For example, the user inputs, from the map input terminal 30, the store map of FIG. 5 as region map information, and the information of the object 500 and the objects 51a to 51c, 52, and 53 arranged in the object 500.

Here, the region map information includes an object expressed by two-dimensional coordinates based on an origin arranged at an arbitrary position. This is not limited to this example, and the region map information may be expressed by three-dimensional coordinates.

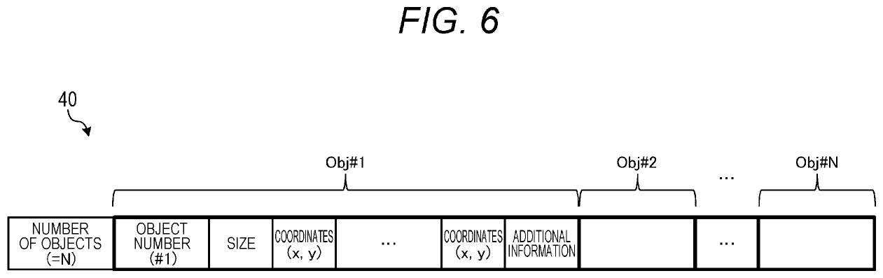

FIG. 6 is a schematic diagram illustrating a format example of region map information applicable to the embodiment. Note that, in FIG. 6 and subsequent similar drawings, the left end is set as the head position of the format. In FIG. 6, region map information 40 includes N pieces of object information Obj #1, Obj #2, . . . , and Obj #N. Here, the N pieces of object information Obj #1, Obj #2, . . . , and Obj #N can include information of the object 500 indicating the target region.

In the example of FIG. 6, the number of pieces of object information Obj #1, Obj #2, . . . , and Obj #N included in the region map information 40 is described in the head region, for example, with the data length as a fixed length, and each of the pieces of object information Obj #1, Obj #2, . . . , and Obj #N is arranged following the head region. Note that, hereinafter, any object information among the pieces of object information Obj #1, Obj #2, . . . , and Obj #N will be described as object information Obj #x.

In the object information Obj #x, an object number, a size, coordinates (x, y), . . . , and additional information are arranged from the head. As the object number, identification information for identifying the object information Obj #x in the region map information 40 is described. As the size, information indicating the data size of the object information Obj #x is described. In each of the object number and the size, for example, the data length is a fixed length.

In each of the coordinates (x, y), . . . , coordinate information for specifying the range of the object indicated in the object information Obj #x is described. In the coordinate information, the number corresponding to the shape of the object indicated by the object information Obj #x is described. In the example of FIG. 5, since the objects 51a to 51c and 52 each have four vertices, four pieces of coordinate information are described. The coordinates of each vertex are described, for example, in a counterclockwise or clockwise order with respect to the object.

It is not limited thereto, and the object may have three vertices or five or more vertices. For example, since the object 53 has five vertices, five pieces of coordinate information are described. Furthermore, for an object having no vertex such as a circle or an ellipse, or an object having a complicated shape, each coordinate (x, y), . . . can be set by approximating a polygon. In each coordinate (x, y), . . . , the data length can be a fixed length, and the data length is variable as a whole.

The additional information is described following each coordinate (x, y), . . . . It is conceivable that the additional information describes, for example, information indicating what the object corresponding to the object information Obj #x specifically indicates. In the additional information, for example, the data length is variable.

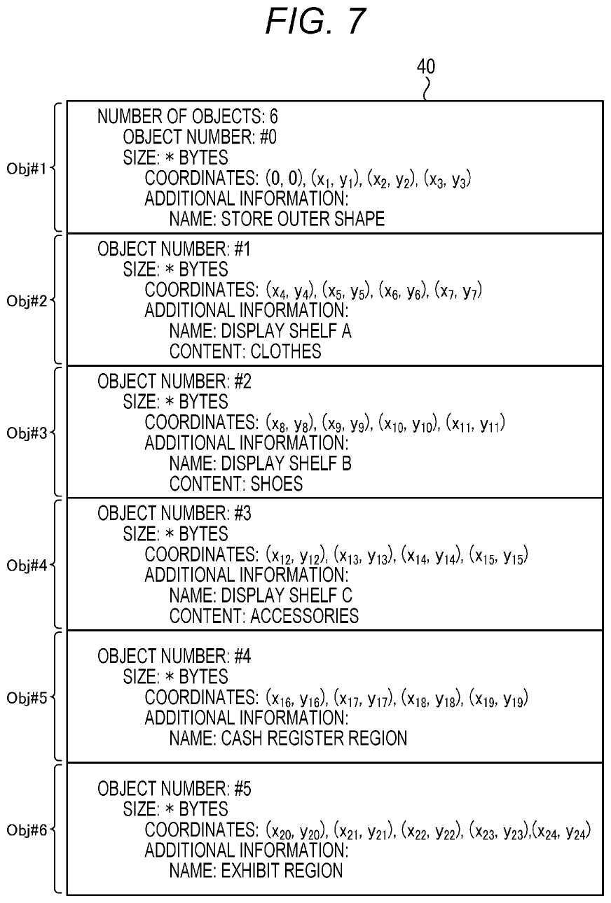

FIG. 7 is a schematic diagram illustrating a specific example of the region map information 40 according to the embodiment. FIG. 7 illustrates an example of the case of the object 500 and the objects 51a to 51c, 52, and 53 illustrated in FIG. 5. In the example of FIG. 7, the hierarchical structure of information is represented by indentation.

In FIG. 7, the number of objects “6” is described at the head of the region map information 40, and then the object information Obj #1 of the object number “#0” is described. The object of the object number “#0” corresponds to the object 500, which is a store outer shape. In the object information Obj #1, the object number is “0”, and the data size of the object information Obj #1 is described as the size in the next row, for example, in byte units. The value described in the size can be a value excluding the size and the size of the object number described above.

After the size, coordinates (0, 0), (x₁, y₁), (x₂, y₂), and (x₃, y₃) are described. In this example, one of the vertices of the object 500 is the origin of the coordinate system related to the object 500. In the next additional information, the name “store outer shape” of the object information Obj #1 is described.

In the following, similarly, the object number, the size, the coordinates, and the additional information are described in each of the pieces of object information Obj #2 to Obj #6.

Note that, in the example of FIG. 7, the hierarchical structure of information is represented by indentation, but it is not limited to this example. Since the information indicating the data length as the size is described in each piece of object information Obj #x, even when the pieces of information are serially arranged, it is possible to identify each piece of object information Obj #x and identify each piece of information inside each piece of object information Obj #x.

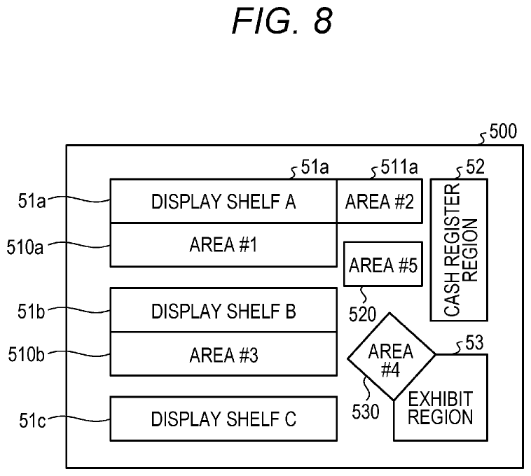

Next, information regarding the analysis target object (hereinafter, analysis target object information) included in the map information will be described. Here, an area is defined for an analysis target object. FIG. 8 is a schematic diagram illustrating an example of an area defined for an analysis target object, which is applicable to the embodiment. In FIG. 8, each 500 and objects 51a to 51c, 52, and 53 are common to each of objects 500, 51a to 51c, 52 and 53 described with reference to FIG. 5.

In the example of FIG. 8, in each of the objects 51a and 51b, areas 510a and 510b (also illustrated as Areas #1 and #2 in the drawing) are defined adjacent to the lower long side in the drawing. In this case, the areas 510a and 510b are floor surface portions having a predetermined range adjacent to the objects 51a and 51b, which are the display shelves A and B, respectively. The floor surface portions having the predetermined range are regarded as objects, and the motion of the moving body in the objects is analyzed.

Furthermore, an area 511a (also illustrated as Area #3 in the drawing) is defined adjacent to the right short side of the object 51a in the drawing. Moreover, an area 520 (also illustrated as Area #5 in the drawing) is defined slightly apart from the left long side of the object 52 in the drawing. Moreover, an area 530 (also illustrated as Area #4 in the drawing) is defined with one side of the rectangle in contact with an oblique side of the object 53. That is, the area 530 can be considered as a rectangular region defined obliquely in the object 500.

Here, it is conceivable that each of the areas 510a, 510b, 511a, 520, and 530 indicates whether there is a relationship with each of the objects 51a to 51c, 52, 53, and 54 arranged on the map. For example, it is conceivable that the areas 510a and 511a are each associated with the object 51a. In this way, associating the object with the definition of the area is considered to be effective in the motion analysis.

The definition of the area includes coordinates of the area and information indicating the object associated with the area. Here, in the definition of the area, it is not always necessary to associate the object, and the coordinates of the area are minimum information. Note that the area can also be defined by information other than coordinates. Furthermore, it is also possible to define an area with which no object is associated, such as the area 520 in FIG. 8.

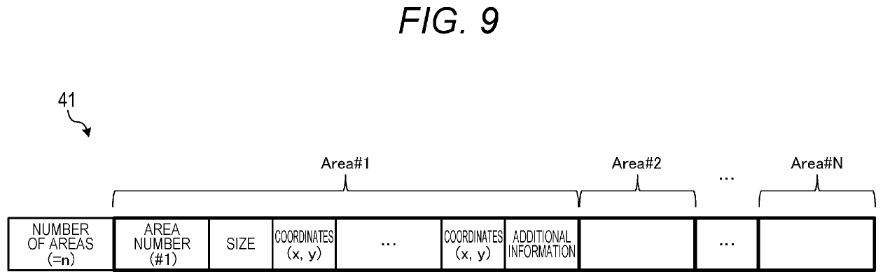

FIG. 9 is a schematic diagram illustrating a format example of analysis target object information defining an area, which is applicable to the embodiment. In FIG. 9, analysis target object information 41 includes n pieces of area information Area #1, Area #2, . . . , and Area #n.

In the example of FIG. 9, the number of area information Area #1, Area #2, . . . , and Area #n included in the analysis target object information 41 is described in the head region, for example, with the data length as a fixed length, and each of the pieces of area information Area #1, Area #2, . . . , and Area #n are arranged following the head region. Note that, hereinafter, arbitrary area information among the area information Area #1, Area #2, . . . , and Area #n will be described as area information Area #x.

In the area information Area #x, an area number, a size, coordinates (x, y), . . . , and additional information are arranged from the head. As the area number, identification information for identifying the area information Area #x in the analysis target object information 41 is described. As the size, information indicating the data size of the area information Area #x is described. In each of the area number and the size, for example, the data length is a fixed length.

In each of the coordinates (x, y), . . . , coordinate information for specifying the range of the area corresponding to the area information Area #x is described. The coordinates of each vertex are described, for example, counterclockwise or clockwise with respect to the area. In the coordinate information, the number corresponding to the shape of the object indicated by the area information Area #x is stored. In the example of FIG. 8, since the areas 510a, 510b, 511a, 520, and 530 each have four vertices, four pieces of coordinate information are described. It is not limited thereto, and similarly to the object described above, the area may have three vertices or five or more vertices. In each coordinate (x, y), . . . , the data length can be a fixed length, and the data length is variable as a whole.

The additional information is stored following each coordinate (x, y), . . . . For example, in a case where the object is associated with the area corresponding to the area information Area #x, the additional information includes identification information (object number) for specifying the object and information indicating which side of the object the area is associated with. Furthermore, for example, in a case where no object is associated with the area corresponding to the area information Area #x, the additional information includes information indicating that fact.

Moreover, the additional information includes information for transforming coordinates of the object associated with the area into local coordinates (described later) in the area. Here, as the information of the side of the area associated with the object, the number for specifying the side, a set of coordinates, and the like can be considered. Furthermore, in a case where a plurality of objects is associated with one area, information (for example, object number) for specifying the plurality of objects associated with the area and information of sides of the objects associated with the area are described in the additional information of the area information Area #x of the area. Note that a configuration in which the area and the object do not have a contact point is also conceivable.

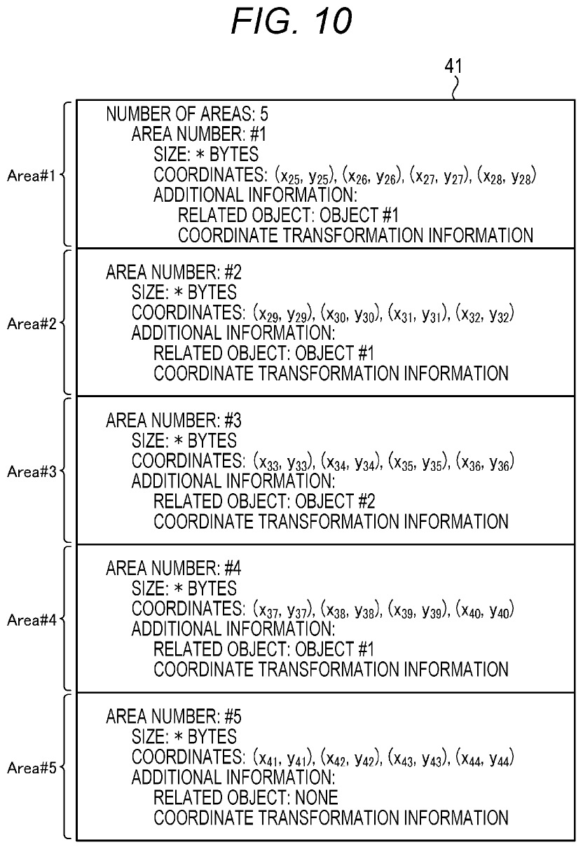

FIG. 10 is a schematic diagram illustrating a specific example of the analysis target object information 41 according to the embodiment. FIG. 10 illustrates an example of the case of the object 500 and the objects 51a to 51c, 52, and 53, and the areas 510a, 510b, 511a, 520, and 530 illustrated in FIG. 8. In the example of FIG. 10, the hierarchical structure of information is represented by indentation.

In FIG. 10, the number of areas “5” is described at the head of the analysis target object information 41, and then the area information Area #1 of the area number “#1” is described. In the area information Area #1, the area number is “1”, and the data size of the area information Area #1 is described as the size in the next row, for example, in byte units. The value described in the size can be a value excluding the size and the size of the area number described above.

After the size, coordinates (x₂₆, y₂₆), (x₂₆, y₂₆), (x₂₇, y₂₇) and (x₂₆, y₂₈) are described. In this example, one of the vertices of the object 500 is the origin of the coordinate system related to the object 500.

In the next additional information, information for specifying an object related to the area information Area #1 is described as a related object. Here, an object number is used as information for specifying an object. Furthermore, in the additional information, information regarding coordinate transformation is described as the coordinate transformation information. As will be described later, the information regarding the coordinate transformation is, for example, a transformation coefficient for transforming the coordinate system (local coordinate system) of the area 510a corresponding to the area information Area #1 into the coordinate system (global coordinate system) of the object 500.

In the following, similarly, the area number, the size, the coordinates, and the additional information are described in each of the pieces of area information Area #2 to Area #5. The area information Area #5 having the area number “#5” and corresponding to the area 530 in FIG. 8 indicates that there is no related object in the additional information. Furthermore, although illustration is omitted, in the analysis target object information 41, by describing a plurality of sets of related objects and coordinate transformation information in the additional information, a plurality of objects can be associated with one area.

Note that, in the example of FIG. 10, the hierarchical structure of information is represented by indentation, but it is not limited to this example. Since the information indicating the data length as the size is stored in each piece of area information Area #x, even when the pieces of information are serially arranged, it is possible to identify each piece of area information Area #x and identify each piece of information inside each piece of area information Area #x.

When the region map information 40 and the analysis target object information 41 described above are input, the map input terminal 30 transmits the region map information 40 and the analysis target object information 41 to the analysis server 20 via the network 2. Upon receiving the region map information 40 and the analysis target object information 41, the analysis server 20 stores the received region map information 40 and analysis target object information 41 in the storage unit 204.

(2-2. Motion Detection Example According to the Embodiment)

Next, detection of the motion of the moving body according to the embodiment will be described. This detection processing is executed in the action analysis unit 202 of the analysis server 20. The action analysis unit 202 converts the position and orientation information periodically transmitted from the positioning environment 10 into collective position and orientation information on the basis of a predetermined condition. The grouped collective information is defined as the motion. The action analysis unit 202 converts the periodic position and orientation information into motion information indicating continuous motion. More specifically, the action analysis unit 202 according to the embodiment assigns a label of motion to position and orientation sample ring data periodically transmitted from the positioning environment 10.

The motion defined in the embodiment will be described. In the embodiment, seven types of motions of “Move”, “Stay”, “Enter”, “Face”, “Remain”, “Pass”, and “Access” are defined.

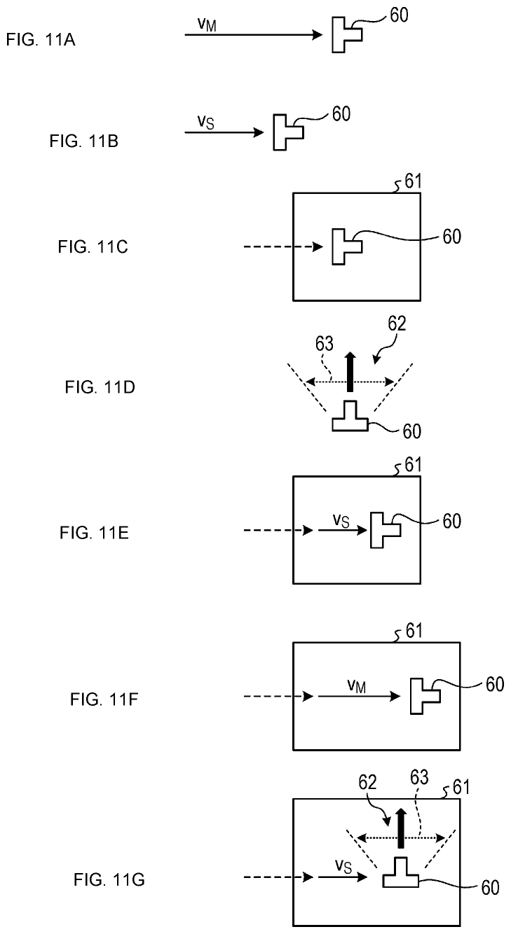

FIG. 11 is a schematic diagram for describing motions defined in the embodiment. Note that, in FIG. 11, a T-shaped protrusion of a moving body 60 indicates its orientation, and, for example, Section (a) of FIG. 11 illustrates a state in which the moving body 60 travels rightward in the drawing.

Furthermore, in FIG. 11, the solid arrows in the horizontal direction indicate the traveling direction, and the front length indicates the velocity.

(Move)

The motion at a certain velocity or more is defined as “Move”. Section (a) of FIG. 11 schematically illustrates a state of the motion type “Move” in which the moving body 60 is performing the motion at a velocity v_{M} equal to or higher than a certain velocity. The velocity of the moving body 60 can be obtained on the basis of the position information and the time stamp included in the sampling data. In the motion type “Move”, it is possible to subdivide the definition according to the level of velocity.

(Stay)

The motion at a velocity less than a certain velocity is defined as “Stay”. Section (b) of FIG. 11 schematically illustrates a state of the motion type “Stay” in which the moving body is performing the motion at a velocity vs less than a certain velocity. It is also conceivable to subdivide the motion type “Stay” according to the level of velocity. The certain velocity in the motion type “Move” and the motion type “Stay” is, for example, information that can be designated for the system (analysis server 20).

(Enter)

The motion in which the position information included in the sampling data is included in the area defined by the analysis target object information 41 is defined as “Enter”. Section (c) of FIG. 11 schematically illustrates a state of the motion type “Enter” in which the moving body 60 is included in an area 61. In the motion type “Enter”, the velocity at which the moving body 60 is included in the area 61 is not defined. The action analysis unit 202 determines the motion type “Enter” using an algorithm of inside-outside determination for a general polygon or the like.

(Face)

The motion in which the moving body 60 faces a specific direction is defined as “Face”. Section (d) of FIG. 11 schematically illustrates a state of the motion type “Face” in which the moving body 60 faces a direction 62 as the specific direction. Here, various methods of designating a specific direction are conceivable. For example, as illustrated as a range 63 in Section (c) of FIG. 11, it is conceivable to set a direction based on the range of an angle designated from 360° as a specific direction. Furthermore, for example, as the specific direction, a specific direction may be designated from each direction obtained by dividing 360° into, for example, regions of a plurality of angles with reduced resolution. In this case, a method of division of 360° may be at equal intervals or may not be at equal intervals. The specific direction defined as the motion type “Face” is, for example, information that can be designated for the system (analysis server 20).

(Remain)

The motion of a combination of the motion type “Stay” and the motion type “Enter” described above is defined as “Remain”. Section (e) of FIG. 11 is a diagram schematically illustrating a state of the motion type “Remain”, illustrating a state in which the (Enter) moving body 60 included in the area 61 moves (Stay) at a velocity vs less than a certain velocity in the area 61. That is, a state in which the moving body has entered a specific area and moves at a slow velocity in the area or a state in which the moving body stops in the area is the motion type “Remain”.

(Pass)

The motion of a combination of the motion type “Move” and the motion type “Enter” described above is defined as “Pass”. Section (f) of FIG. 11 is a diagram schematically illustrating a state of the motion type “Pass”, illustrating a state in which the (Enter) moving body 60 included in the area 61 moves (Move) at a velocity v_{M} equal to or higher than a certain velocity in the area 61. That is, a state in which the moving body has entered a specific area and moves at a certain high velocity in the area is the motion type “Pass”.

(Access)

The motion of a combination of the motion type “Remain” and the motion type “Face” described above is defined as “Access”. Since the motion type “Remain” is the motion of the combination of the motion type “Stay” and the motion type “Enter” as described above, the motion type “Access” is the motion of a combination of the motion types “Stay” and “Enter” and the motion type “Face”. Section (g) of FIG. 11 is a diagram schematically illustrating the “Access” state, illustrating a state in which the (Enter) moving body 60 included in the area 61 moves (Remain) at a velocity vs less than a certain velocity in the area 61 and faces (Face) the direction 62, which is a specific direction in the area 61. That is, a state in which the moving body has entered a specific area and moves at a slow velocity or stops in the area and a state in which the moving body faces a specific direction are the motion type “Access”.

Here, the orientation in “Access” is the direction of the object associated with the area 61 entered by “Enter”. It is not limited thereto, and it is also possible to define another direction as the orientation in “Access” instead of the direction of the object associated with the area 61.

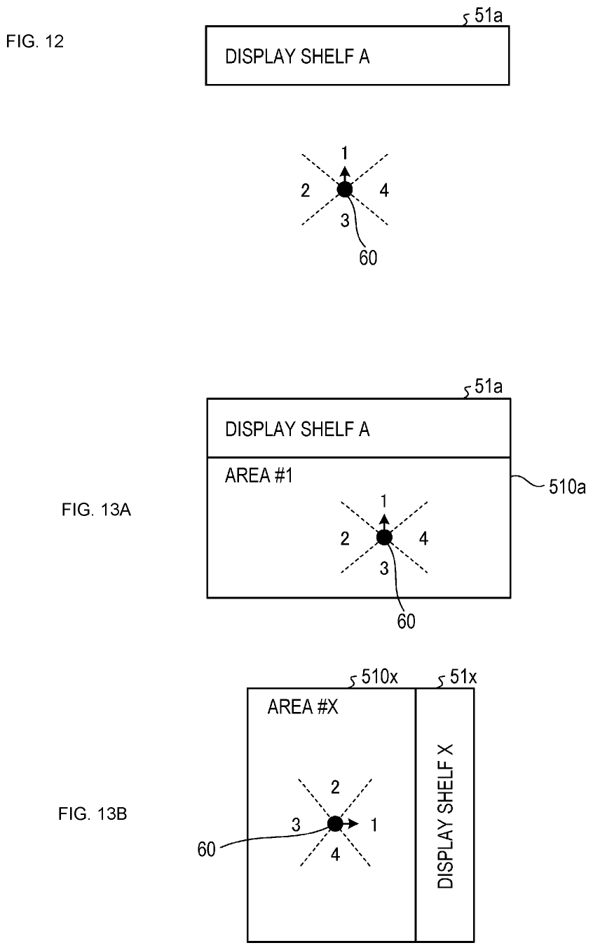

Here, the determination of the orientation (direction of the object) according to the embodiment will be described with reference to FIGS. 12 to 14. Here, an example of determining the orientation on the basis of each divided angle region obtained by dividing 360° into regions will be described. FIG. 12 is a schematic diagram illustrating an example of region division for determining a direction of an object according to the embodiment. In FIG. 12, the object 51a, which is the display shelf A, is used as an example. In the example of FIG. 12, the angle 360° around the moving body 60 is divided into four regions. The four regions are each numbered as Directions [1], [2], [3], and [4] so as to be identifiable. An angle range indicated by Direction [1] is a range in which it is determined that the moving body 60 is facing the direction of the object 51a.

An angle range indicated by Direction [1] is defined below as the range in which it is determined that the moving body is facing the direction of the object.

In the above-described motion types “Face” and “Access”, a rule for determining the facing direction can be provided for each set area. FIG. 13 is a schematic diagram illustrating an example of a case where the direction of each angle range obtained by divided 360° into the four is different for each area.

Section (a) of FIG. 13 is an example in which the area 510a is associated with a longitudinal side of the object 51a arranged with the longitudinal direction coinciding with the horizontal direction in the drawing. In this case, similarly to FIG. 12 described above, Direction [1] is an upper range of the moving body 60 in the drawing. On the other hand, Section (b) of FIG. 13 is an example in which an area 510x is associated with a longitudinal side of an object 51x arranged with the longitudinal direction coinciding with the vertical direction in the drawing. In this case, unlike Section (a) of FIG. 13, Direction [1] is a range in the right direction of the moving body 60 in the drawing. That is, the area 510a in Section (a) of FIG. 13 and the area 510x in Section (b) of FIG. 13 have different coordinate systems.

In the embodiment, the region division for determining the direction in an area is defined with respect to the local coordinate system in the area. That is, in the example of FIG. 8 described above, the local coordinate system set in each of the areas 510a, 510b, 520, and 530 exists with respect to the global coordinate system set in the object 500, which is a store outer shape. The region division for determining the above-described orientation is set for the X-Y plane of each local coordinate system.

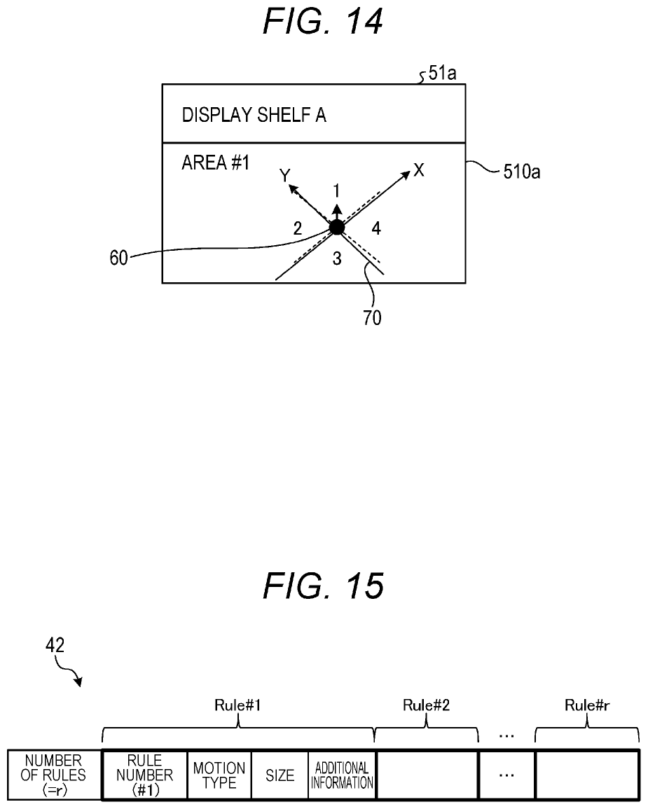

FIG. 14 is a schematic diagram illustrating local coordinates set for an area. In the example of FIG. 14, the local coordinate system in which the position of the moving body 60 is set as the origin and the boundaries obtained by dividing 360° into four are set as the X axis and the Y axis is set to the area 510a. Note that the angle formed by the X axis and the Y axis for performing the angle division is not limited to 90°.

As an example, in the example of FIG. 8 described above, the areas 510a and 510b are associated with the lower sides of the objects 51a and 51b, respectively, in the drawing, and the upper angle range in the drawing is Direction [1]. The area 511a is associated with the left side of the object 51a in the drawing, and the angle range in the left direction in the drawing is Direction [1]. Furthermore, the area 520 is associated with the object 52 on the right side in the drawing, and the angle range in the right direction in the drawing is Direction [1]. Moreover, the area 530 is associated with the obliquely upper left oblique side of the object 53 in the drawing, and the angle range in the lower right direction in the drawing is Direction [1].

For the transformation from the global coordinates to the local coordinates, a general coordinate transformation method can be applied. For example, a method of rotating the Z axis of the global coordinates and aligning the X axis of the local coordinates can be applied. Then, the coordinates in the global coordinate system are transformed into coordinates in the local coordinate system by multiplying the coordinates in the global coordinate system by the rotation matrix. It is similar for the processing of transforming the coordinates in the local coordinate system into the coordinates in the global coordinate system.

(2-3. Motion Analysis Example According to the Embodiment)

Next, the motion analysis of the moving body according to the embodiment will be described. This motion analysis processing is executed in the action analysis unit 202 of the analysis server 20. In the embodiment, a rule including one or more motions of the above-described motions and a condition for the motions is set, and the motion analysis of the moving body 60 is performed according to the set rule.

As an example, the motion type “Access” is the motion of the combination of the motion type “Remain” and the motion type “Face”, and designates how to set the local coordinate system and how to perform region division for each rule. That is, in the motion in which it is necessary to determine the orientation in the local coordinate system among the defined motions, it is necessary to designate each rule similarly to the motion type “Access”.

The types of the motions are not limited to the above-described seven types. For example, another not-exclusive combination of the above-described seven types of motions can be defined as a new motion. For example, it is conceivable to define the motion of a combination of the motion type “Pass” and the motion type “Face”.

FIG. 15 is a schematic diagram illustrating a format example of an analysis rule applicable to the embodiment. In FIG. 15, analysis rule information 42 includes r pieces of rule information Rule #1, Rule #2, . . . , and Rule #r. The analysis rule information 42 can describe the rule information as many as the number of motions to be determined. One piece of rule information defines one motion. The motion associated with the area information Area #x is defined as a different rule in the case of a different area.

In the example of FIG. 15, the number of pieces of rule information Rule #1, Rule #2, . . . , and Rule #r (the number of rules) included in the analysis rule information 42 is stored in the head region, for example, with the data length as a fixed length, and each piece of rule information Rule #1, Rule #2, . . . , and Rule #r is arranged following the head region. Note that, hereinafter, arbitrary rule information among the pieces of rule information Rule #1, Rule #2, . . . , and Rule #r will be described as the rule information Rule #x.

In the rule information Rule #x, a rule number, a motion type, a size, and additional information are arranged from the head. The rule number is identification information for identifying the rule information Rule #x in the analysis rule information 42. As the motion types, information for identifying “Move”, “Stay”, “Enter”, “Face”, “Remain”, “Pass”, and “Access” described above is described. As the size, information indicating the data size of the rule information Rule #x is stored. In each of the rule number, the motion type, and the size, for example, the data length is a fixed length.

The additional information is stored following the size. As the additional information, for example, the area information Area #x associated with the rule corresponding to the rule information Rule #x, the time information, and a threshold value for an angle are described. In the additional information, the area number of the analysis target object information 41 described above is described in the area information Area #x. In the additional information, for example, the data length is variable.

The analysis rule information 42 is input from the map input terminal 30, is included in the map information, and is transmitted to the analysis server 20 via the network 2. The analysis server 20 stores the analysis rule information 42 included in the map information and transmitted via the network 2 in the storage unit 204.

On the basis of the map information stored in the storage unit 204, the action analysis unit 202 executes processing of assigning a label of motion for each piece of sampling data received from the positioning environment 10.

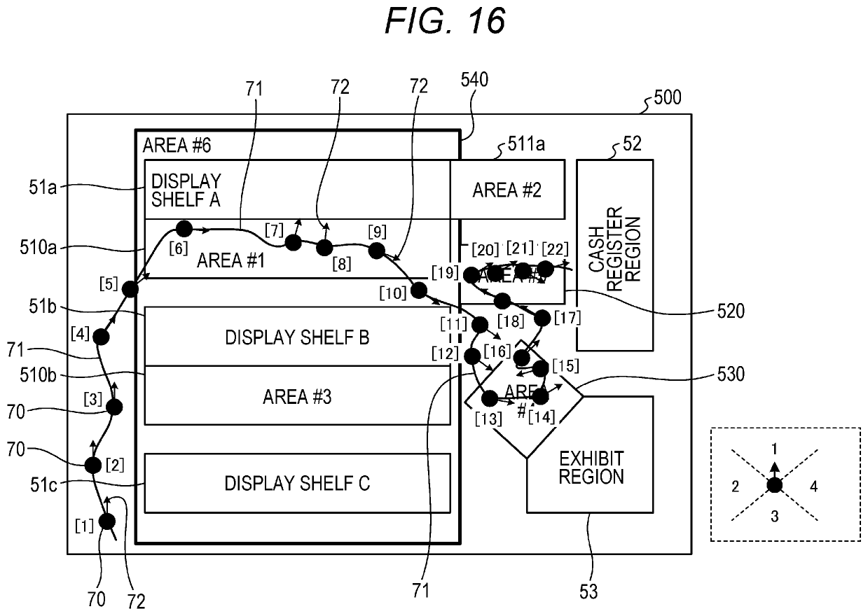

FIG. 16 is a schematic diagram illustrating an example of a trajectory of a motion of the moving body 60. In FIG. 16, each of objects 51a to 51c, 52, and 53, and each of areas 510a, 510b, 511a, 520, and 530 are the same as those in the example of FIG. 8 described above. Furthermore, it is assumed that the moving body 60 is moving while holding the terminal apparatus 1000 including the moving body positioning apparatus 100. The terminal apparatus 1000 transmits the position and orientation information acquired by the moving body positioning apparatus 100 together with the time information (time stamp) as to when the information is acquired to the analysis server 20 via the network 2 as sampling data, for example, at a predetermined cycle such as several 100 [msec] to several [sec].

In FIG. 16, an area 540 is an area including the objects 51a to 51c respectively indicating the display shelves A to C, and the areas 510a and 510b respectively corresponding to the objects 51a and 51b are included in this area 540. Each black dot (⋅) schematically indicates sampling data 70, and the number [x] attached to each black dot indicates a time stamp. The time stamp is added, for example, in units of seconds from the start of sampling. An arrow 72 attached to each black dot indicates the orientation of the moving body 60 in each sampling data 70. Furthermore, a trajectory 71 of the moving body 60 is indicated by a curve connecting the black dots.

Furthermore, an example of region division for determining the motion type “Face” is illustrated by being surrounded by a dotted line at the lower left of FIG. 16. In this example, for the sake of description, in common with each of the areas 510a, 510b, 511a, 520, and 530, the X-Y plane of the object 500 is divided into four angle range regions respectively indicating Directions [1], [2], [3], and [4] according to the global coordinates.

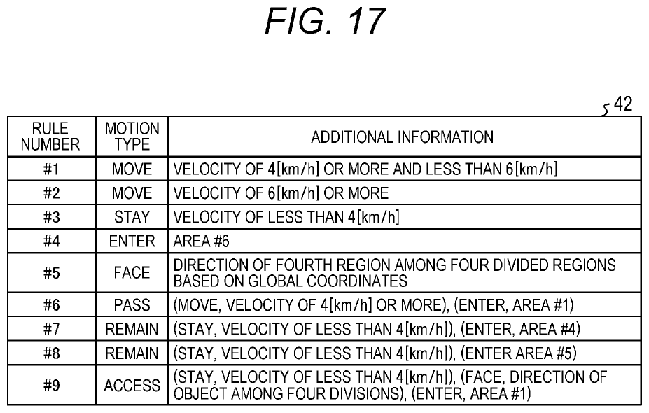

The analysis server 20 performs the motion analysis on the moving motion of the moving body 60 according to the analysis rule information 42 set in a predetermined manner on the basis of the sampling data 70 and the map information. FIG. 17 is a schematic diagram illustrating a specific example of the analysis rule information 42 according to the embodiment. Note that, in FIG. 17, the information of the size is omitted from the analysis rule information 42 described with reference to FIG. 15, and the motion type and the additional information are indicated for each rule number.

In the example of FIG. 17, in the rule of the rule number “#1”, the motion type is “Move”, and a velocity of 4 [km/h] or more and less than 6 [km/h] is designated as the determination condition of the motion type “Move” of the rule number “#1” as the additional information. In the rule of the rule number “#2”, the motion type is the motion type “Move”, and a velocity of 6 [km/h] or more is designated as the determination condition of the motion type “Move” of the rule number “#2” as the additional information. Furthermore, in the rule of the rule number “#3”, the motion type is the motion type “Stay”, and a velocity of less than 4 [km/h] is designated as the determination condition of the motion type “Stay” of the rule number “#3” as the additional information.

In the rule of the rule number “#4”, the motion type is “Enter”, and entering into the area indicated by the area number “#6” is designated as the determination condition of the motion type “Enter” of the rule number “#1” as the additional information. In the rule of the rule number “#5”, the motion type is the motion type “Face” and Direction [4], which is the left direction in the drawing, of the four divided regions based on the global coordinates is used as the orientation determination condition as the additional information.

In the rule of the rule number “#6”, the motion type is “Pass”, and a velocity of 4 [km/h] or more is designated as the determination condition of the motion type “Move” included in the motion type “Pass” as the additional information. Furthermore, entering into the area indicated by the area number “#1” is designated as the determination condition of the motion type “Enter” included in the motion type “Pass”.

In the rule of the rule number “#7”, the motion type is “Remain”, and a velocity of less than 4 [km/h] is designated as the determination condition of the motion type “Stay” included in the motion type “Remain” as the additional information. Furthermore, entering into the area indicated by the area number “#4” is designated as the determination condition of the motion type “Enter” included in the motion type “Remain”.

In the rule of the rule number “#8”, the motion type is “Remain”, and a velocity of less than 4 [km/h] is designated as the determination condition of the motion type “Stay” included in the motion type “Remain” as the additional information. Furthermore, entering into the area indicated by the area number “#5” is designated as the determination condition of the motion type “Enter” included in the motion type “Remain”. As described above, the rule of the rule number “#8” is an example in which only the area designated by the motion type “Enter” is different from the rule of the rule number “#7” described above, and is the rule different from the rule of the rule number “#7”.

In the rule of the rule number “#9”, the motion type is “Access”, and a velocity of less than 4 [km/h] is designated as the determination condition of the motion type “Stay” included in the motion type “Access” as the additional information. Furthermore, entering into the area indicated by the area number “#1” is designated as the determination condition of the motion type “Enter” included in the motion type “Access”. Moreover, in the motion type “Face” included in the motion type “Access”, the direction of the object associated with the area indicated by the area number “#1” is used as the determination condition of the orientation.

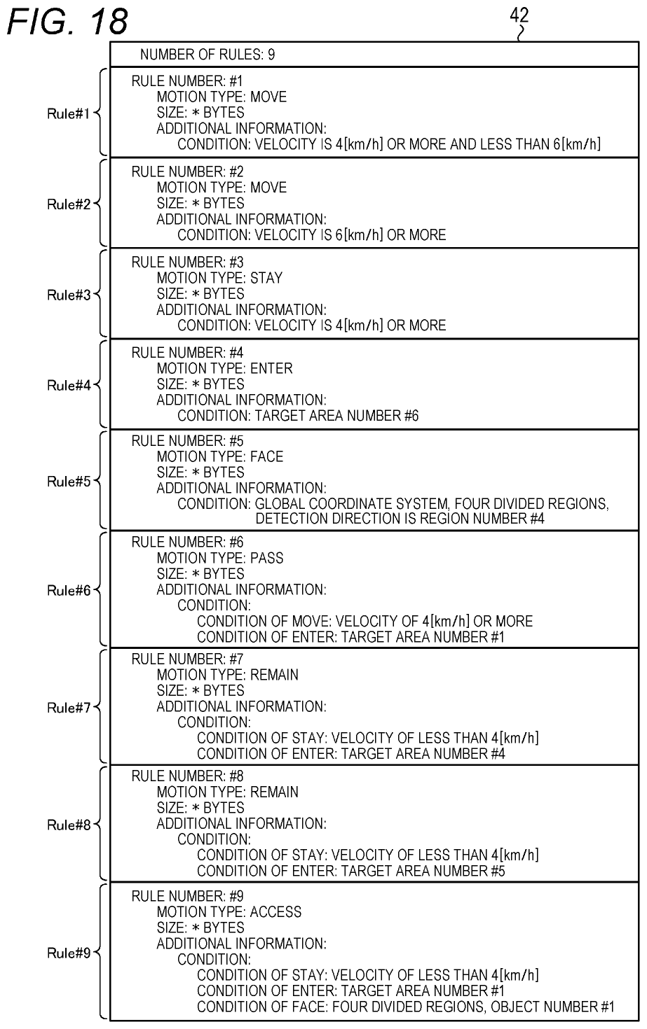

FIG. 18 is a schematic diagram illustrating a specific description example of the analysis rule information 42 described with reference to FIG. 17 according to the embodiment. In the example of FIG. 18, the hierarchical structure of information is represented by indentation.

In FIG. 18, the number of rules “9” is described at the head of the analysis rule information 42, and then, rule information Rule #1 of the rule number “#1” is described. In the rule information Rule #1, the rule number is “#1”, and the motion type “Move” defined in the rule information Rule #1 is described in the next row. The data size of the rule information Rule #1 is described as the size in the next row, for example, in byte units. The value described in the size can be a value excluding the size and the sizes of the rule number and the motion type described above.

The additional information is described next to the size. The additional information can describe a determination condition for the motion type defined in the rule information Rule #x. For example, in the additional information, a determination condition (the velocity is 4 [km/h] or more and less than 6 [km/h]) defined in the rule number “#1” of the rule information Rule #1 is described. For example, in a case where a plurality of determination conditions having different types such as rule information Rule #6 to Rule #9 is defined, the plurality of determination conditions is listed for the additional information.

In the following, similarly, a rule number, a motion type, a size, and additional information are described in each of the rule information Rule #2 to Rule #9.

Note that, in the example of FIG. 18, the hierarchical structure of information is represented by indentation, but it is not limited to this example. Since the information indicating the data length as the size is described in each piece of rule information Rule #x, even when the pieces of information are serially arranged, it is possible to identify each piece of rule information Rule #x and identify each piece of information inside each piece of rule information Rule #x.

FIG. 19 is a flowchart of an example illustrating a method of analyzing the sampling data 70 based on the analysis rule information 42 according to the embodiment. The processing according to the flowchart of FIG. 19 is repeatedly executed for each sampling data 70 for the number of rules described in the analysis rule information 42. For example, the processing of steps S103 to S128 in the flowchart of FIG. 19 is repeated as many times as the number of rules. Hereinafter, for example, in a case where it is not necessary to distinguish the rule numbers “#1” to “#9” illustrated in FIG. 17, the description will be given assuming that the rule numbers “#1” to “#9” are rule number “#x”.

In step S100, the action analysis unit 202 reads the sampling data 70 transmitted from the positioning environment 10. In next step S101, the action analysis unit 202 reads the analysis rule information 42 input from the map input terminal 30 and stored in the storage unit 204.

In next step S102, the action analysis unit 202 performs velocity calculation processing of calculating the velocity of the moving body 60 on the basis of the sampling data read in step S100. For example, the action analysis unit 202 calculates the velocity on the basis of the time stamp of the sampling data 70 read by the immediately preceding processing and the time stamp of the sampling data 70 read by the current processing.

In next step S103, the action analysis unit 202 determines whether or not a rule of the motion type “Move” is described in the target rule number “#x” in the analysis rule information 42. In a case where the action analysis unit 202 determines that the rule of the motion type “Move” is not described (step S103, “No”), the action analysis unit 202 advances the processing to step S106.

On the other hand, in a case where the action analysis unit 202 determines that the rule of the motion type “Move” is described (step S103, “Yes”), the action analysis unit 202 advances the processing to step S104. In step S104, the action analysis unit 202 performs velocity determination processing on the velocity calculated in step S102 according to a condition (velocity condition) described as additional information for the motion type “Move” of the target rule number “#x”. By the velocity determination processing, the action analysis unit 202 determines whether or not ((Yes) or (No)) the velocity calculated in step S102 satisfies the velocity condition described in the target rule number “#x”.

In next step S105, the action analysis unit 202 writes the determination result of step S104 in, for example, the storage unit 204 as analysis result data regarding the motion type “Move”. In a case where the determination result in step S104 is valid (Yes), the action analysis unit 202 writes a label indicating the motion type “Move” in the storage unit 204 as an analysis result. After writing the analysis result, the action analysis unit 202 advances the processing to step S106.

In step S106, the action analysis unit 202 determines whether or not a rule of the motion type “Stay” is described in the target rule number “#x” in the analysis rule information 42. In a case where the action analysis unit 202 determines that the rule of the motion type “Stay” is not described (step S106, “No”), the action analysis unit 202 advances the processing to step S109.

On the other hand, in a case where the action analysis unit 202 determines that the rule of the motion type “Stay” is described (step S106, “Yes”), the action analysis unit 202 advances the processing to step S107. In step S104, the action analysis unit 202 performs velocity determination of determining whether or not ((Yes) or (No)) the velocity calculated in step S102 satisfies the velocity condition described in the target rule number “#x” according to the condition (velocity condition) described as the additional information for the motion type “Stay” of the target rule number “#x”.

In next step S108, the action analysis unit 202 writes the determination result of step S107 in, for example, the storage unit 204 as analysis result data regarding the motion type “Stay”. In a case where the determination result in step S107 is valid (Yes), the action analysis unit 202 writes a label indicating the motion type “Stay” in the storage unit 204 as an analysis result. After writing the analysis result, the action analysis unit 202 advances the processing to step S109.

In step S109, the action analysis unit 202 determines whether or not a rule of the motion type “Face” is described in the target rule number “#x” in the analysis rule information 42. In a case where the action analysis unit 202 determines that the rule of the motion type “Face” is not described (step S109, “No”), the action analysis unit 202 advances the processing to step S112.

On the other hand, in a case where the action analysis unit 202 determines that the rule of the motion type “Face” is described (step S109, “Yes”), the action analysis unit 202 advances the processing to step S110. In step S110, the action analysis unit 202 performs angle determination processing of determining whether or not ((Yes) or (No)) information of the orientation included in the sampling data 70 read in step S100 satisfies an angle range condition described in the target rule number “#x” according to a condition (direction condition) described as the additional information for the motion type “Face” of the target rule number “#x”.

In the angle determination processing, the action analysis unit 202 determines the orientation in accordance with the resolution (for example, four divisions) of the orientation described in the rule number “#x” in the coordinate system corresponding to the target rule number “#x”. In a case where the orientation is determined in the local coordinate system, transformation information is input in coordinate transformation processing to be described later.

In next step S111, the action analysis unit 202 writes the determination result of step S110 in, for example, the storage unit 204 as analysis result data regarding the motion type “Face”. In a case where the determination result in step S110 is valid (Yes), the action analysis unit 202 writes a label indicating the motion type “Face” in the storage unit 204 as an analysis result. After writing the analysis result, the action analysis unit 202 advances the processing to step S112.

In step S112, the action analysis unit 202 determines whether or not a rule of the motion type “Enter” is described in the target rule number “#x” in the analysis rule information 42. In a case where the action analysis unit 202 determines that the rule of the motion type “Enter” is not described (step S112, “No”), the action analysis unit 202 advances the processing to step S115.

On the other hand, in a case where the action analysis unit 202 determines that the rule of the motion type “Enter” is described (step S112, “Yes”), the action analysis unit 202 advances the processing to step S113. In step S113, the action analysis unit 202 performs area determination processing regarding an area including a position on the basis of information of the position included in the sampling data 70 read in step S100 according to a condition (area condition) described as the additional information for the motion type “Enter” of the target rule number “#x”. More specifically, the action analysis unit 202 determines whether or not ((Yes) or (No)) the coordinates indicated by the sampling data 70 are included in the area described in the rule number “#x”.

In next step S114, the action analysis unit 202 writes the determination result of step S113 in, for example, the storage unit 204 as analysis result data regarding the motion type “Enter”. In a case where the determination result in step S113 is valid (Yes), the action analysis unit 202 writes a label indicating the motion type “Enter” in the storage unit 204 as an analysis result. After writing the analysis result, the action analysis unit 202 advances the processing to step S115.

In step S115, the action analysis unit 202 determines whether or not a rule of the motion type “Pass” is described in the target rule number “#x” in the analysis rule information 42. In a case where the action analysis unit 202 determines that the rule of the motion type “Pass” is not described (step S115, “No”), the action analysis unit 202 advances the processing to step S119.

On the other hand, in a case where the action analysis unit 202 determines that the rule of the motion type “Pass” is described (step S115, “Yes”), the action analysis unit 202 advances the processing to step S116. Here, the motion type “Pass” is the combination of the motion type “Move” and the motion type “Enter” and includes at least a first condition (velocity condition) related to the motion type “Move” and a second condition (area condition) related to the motion type “Enter” as conditions.

In step S116, similar to step S104 described above, the action analysis unit 202 performs velocity determination on the velocity calculated in step S102 according to the first condition (velocity condition) described as the additional information for the motion type “Pass” of the target rule number “#x”. In next step S117, similar to step S113 described above, the action analysis unit 202 performs area determination processing regarding an area including a position on the basis of information of the position included in the sampling data 70 read in step S100 according to the second condition (area condition) described as the additional information for the motion type “Pass” of the rule number “#x”.

In next step S118, the action analysis unit 202 writes each of the determination results of steps S116 and S117 in, for example, the storage unit 204 as analysis result data regarding the motion type “Remain”. In a case where the determination results in steps S116 and S117 are valid (Yes), the action analysis unit 202 writes a label indicating the motion type “Pass” in the storage unit 204 as an analysis result. After writing the analysis result, the action analysis unit 202 advances the processing to step 119.

In step S119, the action analysis unit 202 determines whether or not a rule of the motion type “Remain” is described in the target rule number “#x” in the analysis rule information 42. In a case where the action analysis unit 202 determines that the rule of the motion type “Remain” is not described (step S119, “No”), the action analysis unit 202 advances the processing to step S123.

On the other hand, in a case where the action analysis unit 202 determines that the rule of the motion type “Remain” is described (step S119, “Yes”), the action analysis unit 202 advances the processing to step S120. Here, the motion type “Remain” is the combination of the motion type “Stay” and the motion type “Enter” and includes at least the first condition (velocity condition) related to the motion type “Stay” and the second condition (area condition) related to the motion type “Enter” as conditions.

In step S120, similar to step S104 described above, the action analysis unit 202 performs velocity determination on the velocity calculated in step S102 according to the first condition (velocity condition) described as the additional information for the motion type “Pass” of the target rule number “#x”. In next step S121, similar to step S113 described above, the action analysis unit 202 performs area determination processing regarding an area including a position on the basis of information of the position included in the sampling data 70 read in step S100 according to the second condition (area condition) described as the additional information for the motion type “Remain” of the rule number “#x”.

In next step S122, the action analysis unit 202 writes each of the determination results of steps S120 and S121 in, for example, the storage unit 204 as analysis result data regarding the motion type “Remain”. In a case where the determination results in steps S120 and S121 are valid (Yes), the action analysis unit 202 writes a label indicating the motion type “Remain” in the storage unit 204 as an analysis result. After writing the analysis result, the action analysis unit 202 advances the processing to step S123.

In step S123, the action analysis unit 202 determines whether or not a rule of the motion type “Access” is described in the target rule number “#x” in the analysis rule information 42. In a case where the action analysis unit 202 determines that the rule of the motion type “Access” is not described (step S123, “No”), the action analysis unit 202 ends the series of processing according to the flowchart of FIG. 19 and executes processing for the next rule number.

On the other hand, in a case where the action analysis unit 202 determines that the rule of the motion type “Access” is described (step S123, “Yes”), the action analysis unit 202 advances the processing to step S124. Here, the motion type “Access” is the combination of the motion type “Stay”, the motion type “Enter”, and the motion type “Face”, and includes at least the first condition (velocity condition) related to the motion type “Stay”, the second condition (area condition) related to the motion type “Enter”, and a third condition (angle condition) related to the motion type “Face” as conditions.

In step S124, similar to step S104 described above, the action analysis unit 202 performs velocity determination on the velocity calculated in step S102 according to the first condition (velocity condition) described as the additional information for the motion type “Access” of the target rule number “#x”. In next step S121, similar to step S113 described above, the action analysis unit 202 performs area determination processing regarding an area including a position on the basis of information of the position included in the sampling data 70 read in step S100 according to the second condition (area condition) described as the additional information for the motion type “Access” of the rule number “#x”.

In next step S126, the action analysis unit 202 performs coordinate transformation processing of transforming local coordinates in the area determined by the area determination processing in step S125 into global coordinates. That is, the action analysis unit 202 refers to the analysis target object information 41 on the basis of the area number “#x” described in the rule number “#x”, and performs coordinate transformation using the coordinate transformation information described as the additional information of the area number “#x”.

In next step S127, similar to step S110, the action analysis unit 202 performs orientation angle determination processing on the basis of the transformed coordinates obtained by coordinate transformation of the coordinates of the position included in the sampling data 70 read in step S100 in step S126.

In next step S128, the action analysis unit 202 writes each of the determination results of steps S124, S125, and S127 in, for example, the storage unit 204 as analysis result data regarding the motion type “Access”. In a case where the determination results in steps S124, S125, and S127 are valid (Yes), the action analysis unit 202 writes a label indicating the motion type “Access” in the storage unit 204 as an analysis result. After writing the analysis result, the action analysis unit 202 ends the series of processing according to the flowchart of FIG. 19 and executes processing for the next rule number.

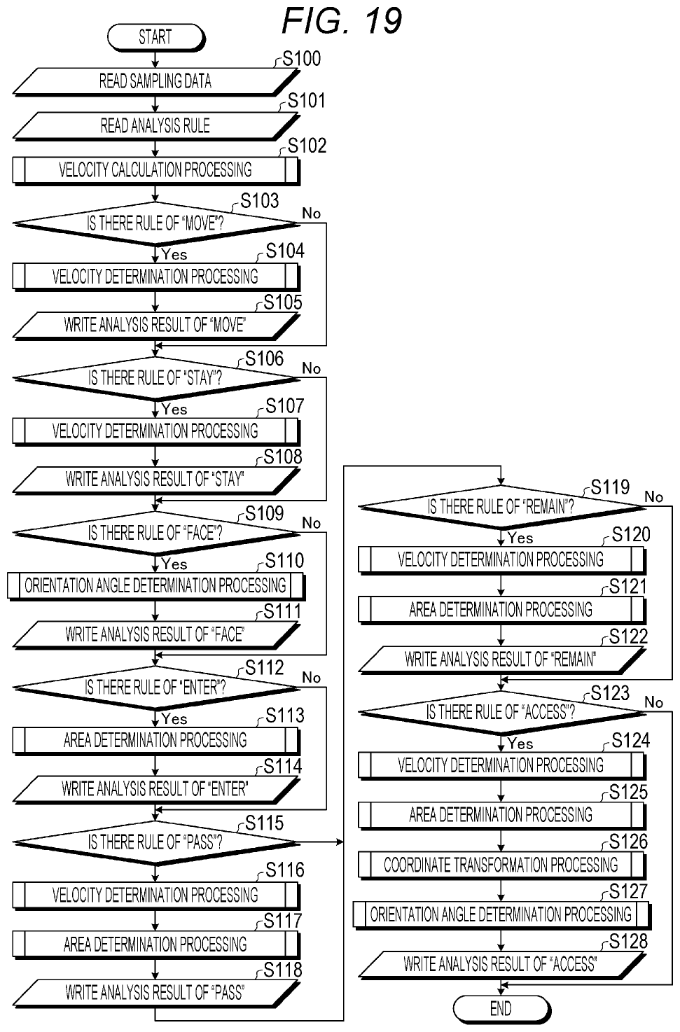

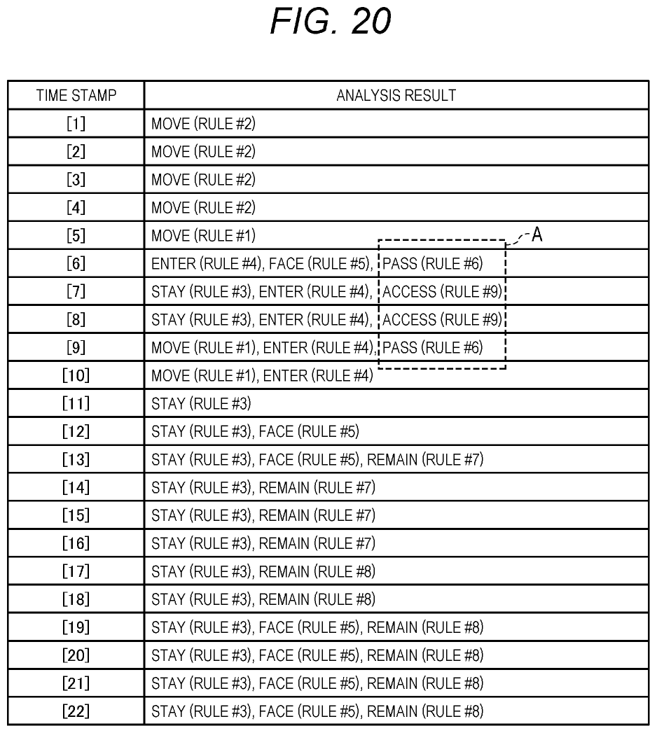

FIG. 20 is a schematic diagram illustrating an example of an analysis result by motion analysis according to the embodiment. In the example of FIG. 20, corresponding to the motion of the moving body 60 illustrated in FIG. 16, the analysis result of each piece of sampling data 70 is illustrated in association with the time stamp indicating the time when each piece of sampling data 70 was acquired. The analysis result is indicated as a label written in the storage unit 204 in steps S105, S108, S111, S114, S118, S122, and S128 of the flowchart illustrated in FIG. 19. In the example of FIG. 20, each label includes the motion type and the rule number indicating the rule in which the motion type is determined.

For example, the action analysis unit 202 acquires the motion type “Move” as an analysis result according to the rule number “#2” for which the velocity determination processing is performed on the basis of the sampling data 70 of Time Stamp [1], and generates the label “Move (Rule #2)”.

In another example, for example, the action analysis unit 202 acquires the motion type “Enter” according to the rule number “#4”, acquires the motion type “Face” according to the rule number “#5”, and further acquires the motion type “Pass” according to the rule number “#6” as an analysis result on the basis of the sampling data 70 of Time Stamp [6], and generates the label “Enter (Rule #4), Face (Rule #5), Pass (Rule #6)”.

The analysis result indicated in this label indicates that, on the basis of the rules of the rule numbers “#4”, “#5”, and “#6”, the moving body 60 is included in the area 540 of the area number “#6”, faces Direction [4], which is the left direction in the drawing among the four divided regions based on the global coordinates, and moves within the area 510a of the area number “#1” at 4 [km/h] or more.

At this time, since the area 510a is completely included in the area 540, there is no contradiction between the analysis result of the motion type “Enter” according to the rule number “#4” and the analysis result of the motion type “Enter” included in the motion type “Pass” according to the rule number “#6”. Furthermore, the orientation analyzed by the rule number “#5” indicates the direction of the object 52, which is a cash register region, and indicates that the moving body 60 does not face the direction of the object 51a. Therefore, from the analysis result of the label “Enter (Rule #4), Face (Rule #5), Pass (Rule #6)”, for example, it can be estimated that the moving body 60 has little interest in the display shelf A.

In still another example, for example, the action analysis unit 202 acquires the motion type “Stay” according to the rule number “#3”, acquires the motion type “Enter” according to the rule number “#4”, and further acquires the motion type “Access” according to the rule number “#9” as an analysis result on the basis of the sampling data 70 of Time Stamp [7], and generates the label “Stay (Rule #3), Enter (Rule #4), Access (Rule #9)”.

The analysis result indicated in this label indicates that, on the basis of the rules of the rule numbers “#3”, “#4”, and “#9”, the moving body 60 moves in the area 540 of the area number “#6” at a velocity of less than 4 [km/h] and faces the direction of the object 51a associated with the area number “#1” among the four divided regions based on the local coordinates of the area 510a within the area 510a of the area number “#1”.

From the analysis result of the label “Stay (Rule #3), Enter (Rule #4), Access (Rule #9)”, for example, it can be estimated that the moving body 60 moves slowly in the area 510a and is interested in the object 51a, that is, the display shelf A.

In yet still another example, for example, the action analysis unit 202 acquires the motion type “Stay” according to the rule number “#3”, acquires the motion type “Face” according to the rule number “#5”, and further acquires the motion type “Remain” according to the rule number “#8” as an analysis result on the basis of the sampling data 70 of Time Stamp [20], and generates the label “Stay (Rule #3), Face (Rule #5), Remain (Rule #8)”.

The analysis result indicated in this label indicates that, on the basis of the rules of the rule numbers “#3”, “#5”, and “#8”, the moving body 60 faces Direction [4], which is the left direction in the drawing among the four divided regions based on the global coordinates, at a velocity of less than 4 [km/h], and moves within the area 520 of the area number “#5” at a velocity of less than 4 [km/h]. The area 520 is an area in front of the object 52, which is a cash register region, and Direction [4] indicates the direction of the object 52 in the area 520.

From the analysis result of the label “Stay (Rule #3), Face (Rule #5), Remain (Rule #8)”, for example, it can be estimated that the moving body 60 is waiting in front of the cash register apparatus to pay for a purchased product.

### 3. Example of Visualization Expression of Motion According to the Embodiment

Next, an example of drawing of each motion on the basis of the analysis result according to the embodiment will be described. In the embodiment, the drawing information creation unit 203 creates visualization information for display on the basis of each label described with reference to FIG. 20. At this time, the drawing information creation unit 203 creates visualization information for displaying a specific motion differently from another motion on the basis of the analysis result. More specifically, the drawing information creation unit 203 according to the embodiment creates visualization information such that the display based on the label including the motion type “Access” is different from the display based on the label not including the motion type “Access”.

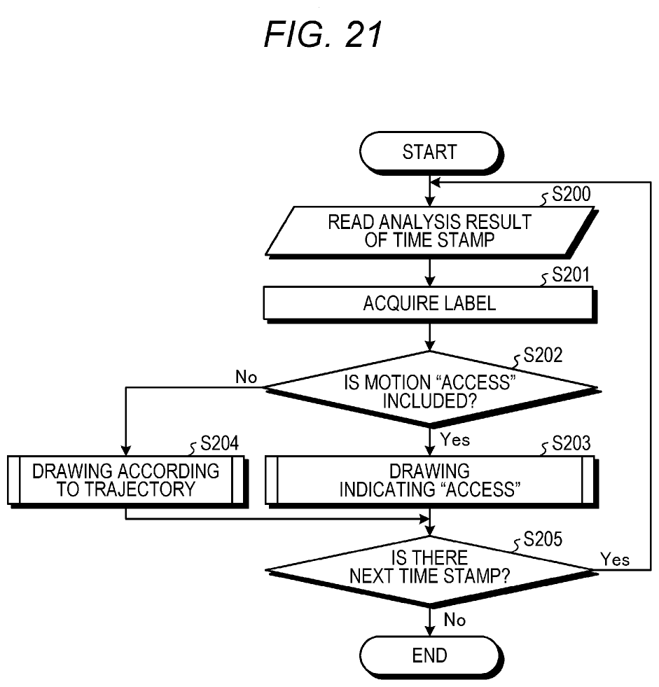

FIG. 21 is a flowchart of an example illustrating drawing information creation processing by the drawing information creation unit 203 according to the embodiment. Prior to the processing according to the flowchart of FIG. 21, the drawing information creation unit 203 reads, for example, the analysis result illustrated in FIG. 20 from the storage unit 204. The processing according to the flowchart of FIG. 21 is executed as loop processing of repeating steps S200 to S205 for each Time Stamp [x] of the analysis result.

In step S200, the drawing information creation unit 203 reads an analysis result of Time Stamp [x]. In next step S201, the drawing information creation unit 203 acquires a label included in the analysis result read in step S200. At this time, in a case where the analysis result includes a plurality of labels such as Time Stamp [6] in FIG. 20, the drawing information creation unit 203 collectively acquires the plurality of labels.

Next, in step S202, the drawing information creation unit 203 determines whether or not the motion type “Access” is included in the label acquired in step S201. In a case where it is determined to be included (step S202, “Yes”), the drawing information creation unit 203 advances the processing to step S203. In step S203, the drawing information creation unit 203 creates visualization information for visualizing the motion type “Access” as the visualization information related to the label.

On the other hand, in a case where the drawing information creation unit 203 determines that the motion type “Access” is not included in the acquired label in step S202 (step S202, “No”), the drawing information creation unit 203 advances the processing to step S204. In step S204, the drawing information creation unit 203 is. On the basis of the acquired label, visualization information for visualizing the trajectory of the movement of the moving body 60 is created. For example, in a case where the label includes the motion type “Move” or the motion type “Stay”, the drawing information creation unit 203 can create visualization information for visualizing the trajectory of the movement on the basis of the position information and the time stamp included in the sampling data 70.

After creating the drawing information in step S203 or S204, the drawing information creation unit 203 advances the processing to step S205. In step S205, the drawing information creation unit 203 determines whether or not there is an unprocessed time stamp in the analysis result. In a case where it is determined that there is an unprocessed time stamp (step S205, “Yes”), the drawing information creation unit 203 returns the processing to step S200 and executes the processing of next Time Stamp [x+1].

On the other hand, in step S205, the drawing information creation unit 203 determines that there is no unprocessed Time Stamp [x], that is, the processing has ended for all Time Stamps [x] included in the analysis result, and ends the series of processing according to the flowchart of FIG. 21.

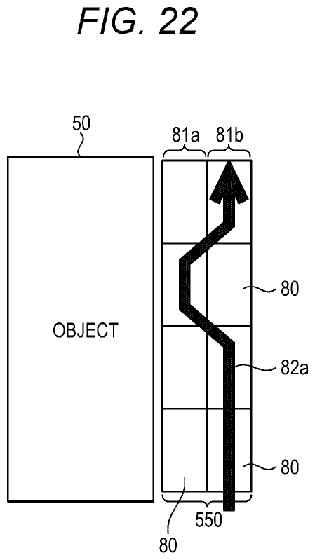

FIG. 22 is a diagram schematically illustrating an example of display by visualization expression on the basis of visualization information created by the drawing information creation unit 203 according to the embodiment. Note that, in FIG. 22, an area 550 is associated with an object 50. In the area 550, each box 80 indicates a unit of drawing in the area 550. Furthermore, in the area 550, a region in which the boxes 80 are arranged in one column along a side (a longitudinal side of the object 50 in the example of FIG. 22) along which the area 550 is associated with the object 50 is referred to as a lane, and in the example of FIG. 22, a lane 81a close to the object 50 and a lane 81b away from the object 50 are illustrated.

In a case where the label related to the analysis result includes the motion type “Pass”, a drawn line 82a indicating the motion of the moving body 60 (not illustrated) is drawn in the lane 81b. On the other hand, in a case where the label related to the analysis result includes “Access”, the drawn line 82a is drawn in the lane 81a. That is, the drawn line 82a in a case where the motion type “Access” is included is drawn by being displaced in position toward the object 50 side with respect to the case where the motion type “Pass” is included. Therefore, it is visualized that the moving body 60 has taken an action of the motion type “Access” with respect to the object 50, and the action can be explicitly indicated.

Note that, in the example of the analysis rule information 42 described with reference to FIG. 17, the motion type “Access” is set such that the velocity is less than 4 [km/h], whereas the motion type “Pass” is set such that the velocity is 4 [km/h] or more, and it can be seen that the motion type “Access” and the motion type “Pass” are incompatible motions. Furthermore, in the analysis rule information 42, the motion including the condition of facing the direction of the object as the condition of the orientation is only the motion type “Access”. Therefore, the motion type “Access” is defined as a motion incompatible with all the other motions defined in the analysis rule information 42.

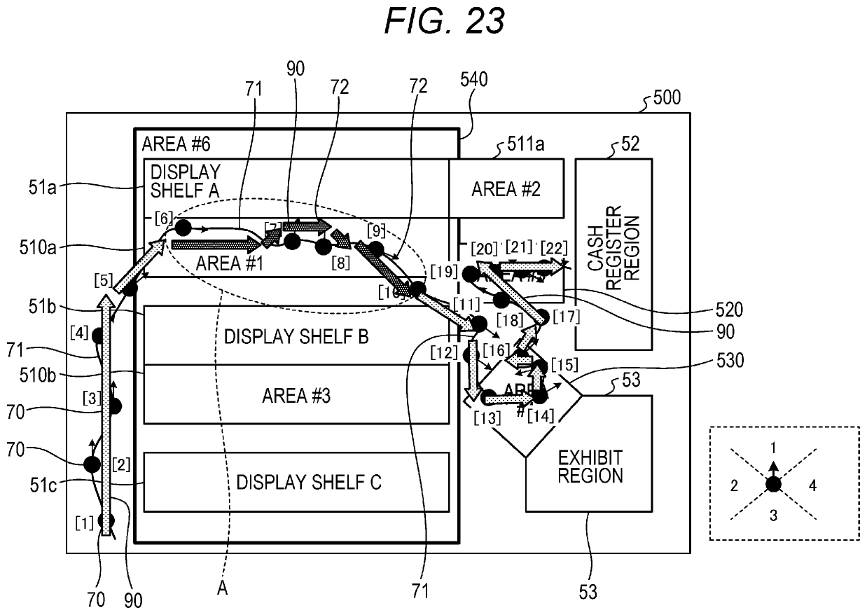

FIG. 23 is a schematic diagram illustrating an example in which a visualization expression based on an analysis result according to the embodiment described with reference to FIG. 20 is applied to the trajectory of the moving body illustrated in FIG. 16. Each drawn line 90 indicates a visualization expression based on the analysis result of FIG. 20, that is, a line by drawing. Since the labels of Time Stamps [1] to [5] are the motion type “Move”, the drawn line 90 is drawn as a simple line on the basis of the position information included in the sampling data 70 and the time (time stamp) when the sampling data 70 is acquired.

Time Stamps [6] to [9] correspond to drawn lines 90 in Range A surrounded by the dotted line in FIG. 23. Corresponding analysis results are similarly indicated by being surrounded by Range A in FIG. 20. In Time Stamps [6] to [9], Time Stamps [7] and [8] include the motion type “Access” in the labels, and it can be estimated that the moving body 60 has performed the motion in consideration of the orientation. Therefore, the drawn lines 90 based on Time Stamps [7] and [8] are drawn so as to be displaced from the trajectory 71 toward the object 51a side with respect to the drawn lines 90 along the trajectory 71 of the moving body 60 on the basis of Time Stamps [6] and [9]. With this drawing, it is possible to estimate in which part of the object 51a, that is, the display shelf A, the moving body 60 has shown an interest.

Time Stamps [10] to [18] indicate the motion in which the moving body 60 leaves the area 540 and slowly moves in the vicinity of the area 530 associated with the object 53, which is an exhibit region. In Time Stamps [10] to [18], since the analysis result does not include the motion type “Access”, the drawn lines 90 are drawn along the trajectory 71 of the moving body 60. Furthermore, in Time Stamps [19] to [22], similarly, since the analysis result does not include the motion type “Access”, the drawn lines 90 are drawn along the trajectory 71 of the moving body 60. In the case of Time Stamps [19] to [22], it can be inferred that the moving body 60 faces the direction of the object 52, which is a cash register region, according to the motion type “Face”, and that congestion has occurred in the area 520 in the immediate vicinity of the cash register region according to the motion type “Stay” and the motion type “Remain”.

Note that the drawn lines 90 are not intended to track the trajectory 71 of the moving body 60, but are intended to explicitly indicate in which direction the moving body 60 has faced. Therefore, as can be seen by comparing the position of each sampling data 70 with the drawn lines 90 in FIG. 23, the drawn lines 90 do not necessarily need to coincide with the position information.

As described above, according to the embodiment of the present disclosure, abstraction of the motion of the moving body 60 is performed from the position and orientation information of the moving body 60, a label is given to the abstracted motion, and a visualization expression for visualizing the motion of the moving body 60 is generated on the basis of the label. By abstracting the motion of the moving body 60, it is possible to easily draw an action including the orientation of the moving body 60.

(3-1. Other Visualization Expression Examples)

(Example of Second Visualization Expression)

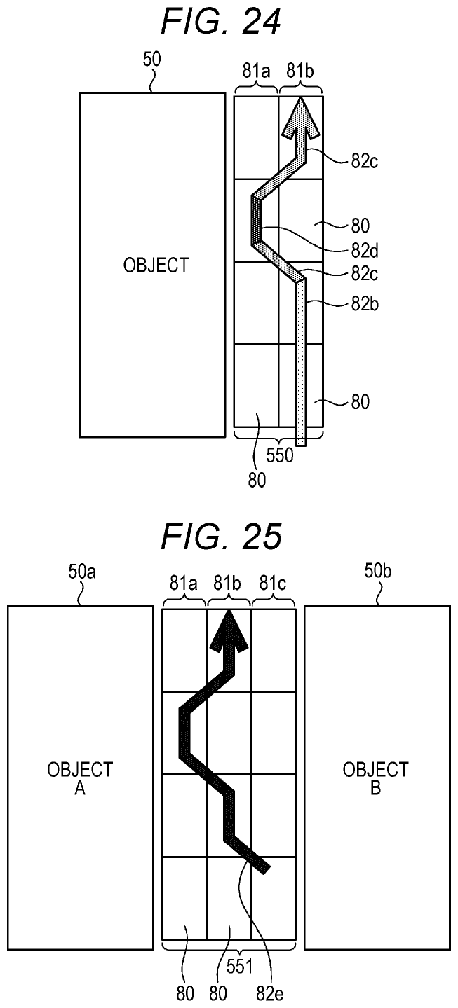

Next, an example of another visualization expression of the motion applicable to the embodiment of the present disclosure will be described. The example described with reference to FIG. 22 is an example of the first visualization expression, and FIG. 24 is a schematic diagram illustrating an example of the second visualization expression applicable to the embodiment. The example of the second visualization expression is an example of changing the color of the drawn lines according to the velocity of the moving body 60 in addition to the example of the first visualization expression of FIG. 22. In the example of FIG. 24, the velocity is expressed by the density of painting, and a drawn line 82b, which is lightly painted, indicates a higher velocity and a drawn line 82d, which is densely painted, indicates a lower velocity with respect to a drawn line 82c, which is painted at an intermediate density. Therefore, it is possible to grasp the motion of the moving body 60 in more detail. This example of the second visualization expression is applicable to both the motion type “Move” and the motion type “Stay”.

(Example of Third Visualization Expression)

FIG. 25 is a schematic diagram illustrating an example of a third visualization expression applicable to the embodiment. This third display example is an example of a case where the moving body 60 passes between objects. In the example of FIG. 25, an area 551 is associated with each of two objects 50a and 50b. Here, in each box 80 of the area 551, each box 80 adjacent to the object 50a is a lane 81a, each box 80 adjacent to the object 50b is a lane 81c, and each box 80 not adjacent to any of the objects 50a and 50 is a lane 81b.

A drawn line 82e of the motion type “Access” facing the direction of each of the objects 50a and 50b is drawn in the lanes 81a and 81c adjacent to each of the objects 50a and 50b. In the example of FIG. 25, it can be seen that the moving body 60 first travels while facing the direction of the object 50b, then travels without facing either direction of the objects 50a and 50b, and further travels while facing the direction of the object 50a.

(Example of Fourth Visualization Expression)

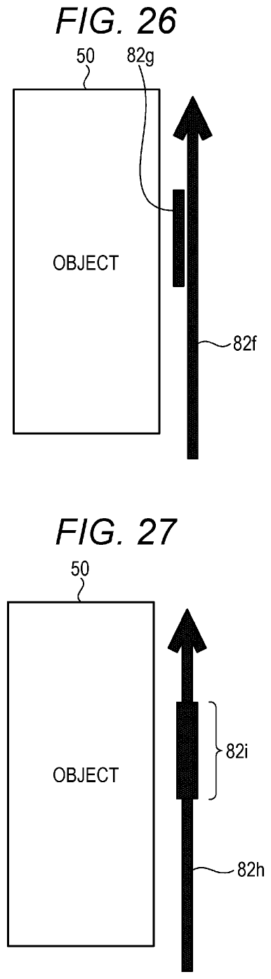

FIG. 26 is a schematic diagram illustrating an example of a fourth visualization expression applicable to the embodiment. In this example of the fourth visualization expression, as illustrated in FIG. 26, a plurality of drawn lines 82f and 82g is drawn only in the section of the motion type “Access”, and the section of the motion type “Access” is emphasized.

(Example of Fifth Visualization Expression)

FIG. 27 is a schematic diagram illustrating an example of a fifth visualization expression applicable to the embodiment. In the example of the fifth visualization expression, as illustrated in FIG. 27, with respect to a drawn line 82h, only for the section of the motion type “Access”, the section of the motion type “Access” is emphasized using a drawn line 82i wider than the drawn line 82h.

(Example of Sixth Visualization Expression)

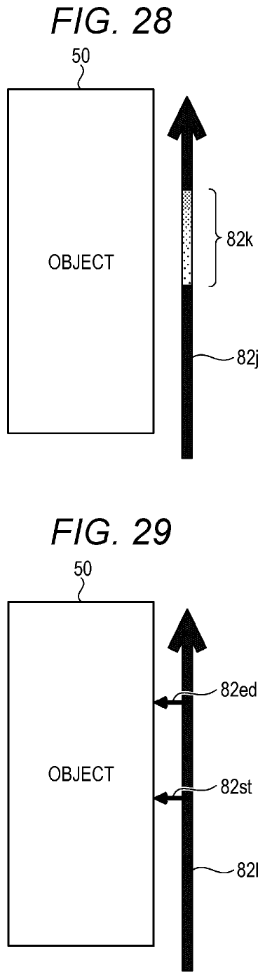

FIG. 28 is a schematic diagram illustrating an example of the sixth visualization expression applicable to the embodiment. As illustrated in FIG. 28, the example of the sixth visualization expression is an example in which with respect to a drawn line 82j, the section of the motion type “Access” is emphasized using a drawn line 82k having a design different from that of the drawn line 82j only for the section of the motion type “Access”. In this example, the drawn line 82j is a line subjected to uniform painting, whereas the drawn line 82k has gradation in which the density changes according to the traveling direction.

(Example of Seventh Visualization Expression)

FIG. 29 is a schematic diagram illustrating an example of the seventh visualization expression applicable to the embodiment. As illustrated in FIG. 29, the example of the seventh visualization expression is an example in which arrows 82st and 82ed indicating the start and end of the section of the motion type “Access” are added to a drawn line 82l in the direction of facing by the motion type “Access”, and the section of the motion type “Access” is emphasized.

(Example of Eighth Visualization Expression)

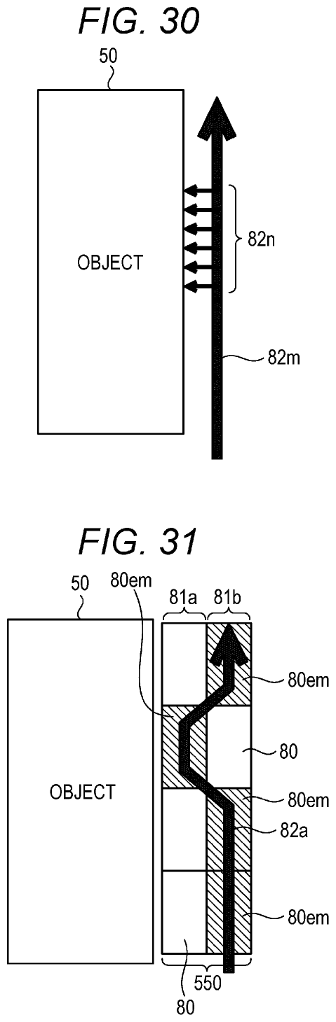

FIG. 30 is a schematic diagram illustrating an example of the eighth visualization expression applicable to the embodiment. As illustrated in FIG. 30, the example of the eighth visualization expression is an example in which a plurality of arrows 82n indicating the direction of facing by the motion type “Access” is added to the section of the motion type “Access” with respect to a drawn line 82m and the section of the motion type “Access” is emphasized.

(Example of Ninth Visualization Expression)

FIG. 31 is a schematic diagram illustrating an example of the ninth visualization expression applicable to the embodiment. The example of the eighth visualization expression is an example of emphasizing the unit of drawing related to a motion type in the motion type related to an area, such as the motion type “Enter”, “Remain”, “Pass”, and “Access”. In the example of FIG. 31, a box 80em of the unit of drawing in which a drawn line 82a is drawn is emphasized and displayed with respect to other boxes 80. It is not limited thereto, and for example, it is also conceivable to emphasize and display an entire area 550 associated with an object 50 in the direction of facing by the motion type “Access”.

(Example of Tenth Visualization Expression)

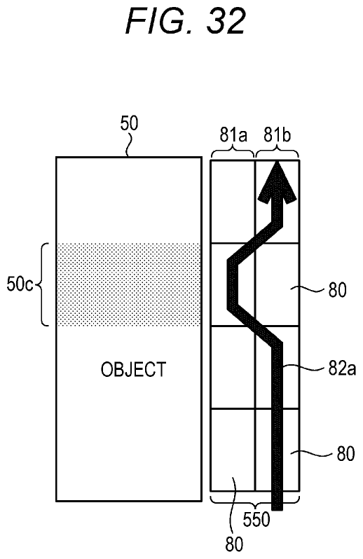

FIG. 32 is a schematic diagram illustrating an example of the tenth visualization expression applicable to the embodiment. As illustrated in FIG. 32, the example of the tenth visualization expression is an example in which the section of the motion type “Access” is emphasized by changing the drawing of a region 50c of an object 50 corresponding to the section of the motion type “Access”.

Note that the above-described examples of the first to tenth visualization expressions can be combined within a range not contradictory to each other.

### 4. First Modification of the Embodiment

Next, the first modification of the embodiment of the present disclosure will be described. In the information processing system 1a according to the above-described embodiment, the positioning environment 10 and the analysis server 20 are connected via the network 2 having a wire area, and the sampling data 70 acquired in the positioning environment 10 is transmitted to the analysis server 20 via the network 2, and the motion of the moving body 60 is analyzed. On the other hand, in the first modification of the present embodiment, the analysis server 20 is installed in a region to be subjected to the action analysis, and processing is completed in the region.

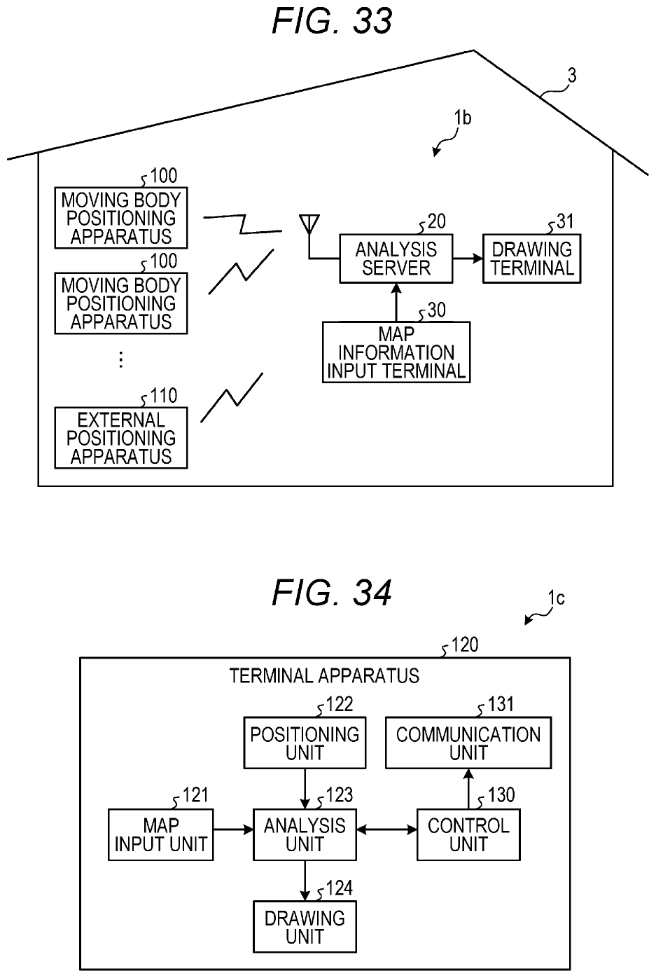

FIG. 33 is a block diagram illustrating a configuration example of an information processing system according to the first modification of the embodiment. In FIG. 33, an information processing system 1b is constructed in a region to be subjected to the action analysis, for example, inside a building 3. The building 3 may be divided into a plurality of parts, but the analysis server 20 is configured to be able to execute communication with the moving body positioning apparatus 100 and the external positioning apparatus 110 without going through an external wide area network such as the Internet. In the case of this example, the analysis server 20, the map input terminal 30, and the drawing terminal 31 can be configured by one information processing apparatus, which is advantageous with respect to the information processing system 1a according to the embodiment in terms of maintainability and the like.

### 5. Second Modification of the Embodiment

Next, the second modification of the embodiment of the present disclosure will be described. The second modification of the embodiment is an example in which some or all of the functions of the analysis server 20 are provided on the moving body positioning apparatus 100 side.

FIG. 34 is a block diagram illustrating a configuration example of an information processing system according to the second modification of the embodiment. In the example of FIG. 34, in an information processing system 1c, a terminal apparatus 120 includes the functions of the analysis server 20, the map input terminal 30, and the drawing terminal 31. That is, the terminal apparatus 120 includes a map input unit 121 having the function of the map input terminal 30 in FIG. 1, a positioning unit 122 having the function of the moving body positioning apparatus 100, an analysis unit 123 having the function of the analysis server 20, and a drawing unit 124 having the function of the drawing terminal 31. The terminal apparatus 120 controls the entire operation of the terminal apparatus 120. Furthermore, a communication unit 131 controls communication with, for example, a network such as the Internet.

As a hardware configuration of such terminal apparatus 120, the configuration of the terminal apparatus described with reference to FIG. 4 can be applied as it is. Among the above-described units, the map input unit 121, the analysis unit 123, and the drawing unit 124 having the function of the drawing terminal 31 excluding the positioning unit 122 are realized by, for example, an information processing program stored in advance in the storage apparatus 1014 (see FIG. 4) operating on the CPU 1010. It is not limited thereto, and some or all of the map input unit 121, the analysis unit 123, and the drawing terminal 31 may be configured by hardware circuits that cooperate with each other.

The information processing program is provided in a state of being stored in a predetermined storage medium, and is installed in the terminal apparatus 120. It is not limited thereto, and the information processing program may be downloaded and installed in the terminal apparatus 120 via a wide area network such as the Internet.

The information processing program has a module configuration including, for example, the map input unit 121, the analysis unit 123, and the drawing unit 124 having the function of the drawing terminal 31. As actual hardware, when the CPU 1010 reads and executes the information processing program from a storage medium such as the storage apparatus 1014, for example, the above-described units are loaded onto a main storage apparatus such as the RAM 1012, and the units are generated on the main storage apparatus.

As the terminal apparatus 120, a smartphone, a tablet computer, or the like can be applied, and in this case, the above-described information processing program is provided as an application program (app) operating on the smartphone or the tablet computer. Furthermore, in the case of use in a store or the like, it is conceivable to embed the map information in the app provided by the store in advance. For example, the user who uses the store can objectively grasp his/her own action by using the terminal apparatus 120 configured as described above.

Furthermore, the terminal apparatus 120 having the above-described configuration can perform only its own action analysis, but can comprehensively analyze the action of a plurality of moving bodies 60 by transmitting the analysis result to an aggregation server provided so as to be connectable via, for example, a wide area network such as the Internet. For example, it is conceivable that the store side provides the information processing program according to the second modification of this embodiment to the user as part of some service, and aggregates the analysis result after obtaining the user's approval.

Note that the effects described in the present description are merely illustrative and are not limitative, and other effects may be provided.

Note that the present technology may be configured as below.

(1) An information processing apparatus including:

an acquisition unit that acquires at least a position and an orientation of a moving body; and

an analysis unit that generates a label indicating a motion of the moving body on the basis of the position and the orientation acquired by the acquisition unit and time when the acquisition unit acquired the position and the orientation.

(2) The information processing apparatus according to (1), further including:

a generation unit that generates, on the basis of the label, visualization information including a visualization expression for visualizing the motion of the moving body.

(3) The information processing apparatus according to (2), in which

the generation unit generates the visualization information related to a change in the position of the moving body and the visualization information related to the orientation indicating a specific direction on the basis of the label.

(4) The information processing apparatus according to (3), in which

the generation unit generates the visualization information as the visualization expression of the orientation by displacing the visualization expression of the change in the position in a range of the orientation indicating the specific direction in the specific direction on the basis of the label.

(5) The information processing apparatus according to (3), in which

the generation unit generates the visualization information as the visualization expression of the orientation by emphasizing the visualization expression of the change in the position in a range of the orientation indicating the specific direction on the basis of the label.

(6) The information processing apparatus according to (3), in which

the generation unit generates the visualization information as the visualization expression of the orientation by indicating a start position and an end position of a range of the orientation indicating the specific direction in the visualization expression of the change in the position on the basis of the label.

(7) The information processing apparatus according to any of (3) to (6), in which

the generation unit

generates the visualization information for each unit obtained by dividing a two-dimensional plane in a predetermined manner, and

generates the visualization information as the visualization expression of the orientation by emphasizing a unit including the change in the position and a unit including a range of the orientation indicating the specific direction.

(8) The information processing apparatus according to any of (3) to (7), in which

the generation unit generates the visualization information in which, in a range of the orientation indicating the specific direction, the visualization expression of a portion of an object corresponding to the specific direction corresponding to the range is a visualization expression different from the visualization expression of another portion of the object on the basis of the label.

(9) The information processing apparatus according to any of (1) to (8), in which

the analysis unit acquires the orientation on the basis of a direction of an object associated with an area in which the motion of the moving body is defined on local coordinates defined in the area.

(10) The information processing apparatus according to (9), in which

the analysis unit acquires the orientation in units of divided regions obtained by dividing the local coordinates by a plurality of straight lines passing through an origin.

(11) The information processing apparatus according to any of (1) to (10), in which

the analysis unit generates the label according to a state of the moving body detected on the basis of at least one of the position, the orientation, and the time.

(12) The information processing apparatus according to (11), in which

the analysis unit generates the label on the basis of a velocity of the moving body.

(13) The information processing apparatus according to (11) or (12), in which

the analysis unit generates the label on the basis of the orientation of the moving body.

(14) The information processing apparatus according to any of (11) to (13), in which

the analysis unit generates the label on the basis of the position of the moving body.

(15) The information processing apparatus according to (14), in which

the analysis unit generates the label according to entering of the moving body into an area in which the motion of the moving body is defined on the basis of the position.

(16) The information processing apparatus according to any of (1) to (15), in which

the analysis unit generates the label on the basis of one or more motions designated according to a preset rule.

(17) The information processing apparatus according to any of (1a) to (16),

receiving the position and the orientation from a terminal apparatus associated with the moving body.

(18) The information processing apparatus according to any of (1) to (16), further including:

a detection unit that detects the position and the orientation.

(19) An information processing method executed by a processor, including:

an acquisition step of acquiring at least a position and an orientation of a moving body; and

an analysis step of generating a label indicating a motion of the moving body on the basis of the position and the orientation acquired by the acquisition step and time when the position and the orientation were acquired by the acquisition.

(20) An information processing program for causing a computer to execute:

an acquisition step of acquiring at least a position and an orientation of a moving body; and

an analysis step of generating a label indicating a motion of the moving body on the basis of the position and the orientation acquired by the acquisition step and time when the position and the orientation were acquired by the acquisition.

### REFERENCE SIGNS LIST

1a, 1b, 1c Information processing system
10 Positioning environment
20 Analysis server
30 Map input terminal
31 Drawing terminal
40 Region map information
41 Analysis target object information
42 Analysis rule information
50, 50a, 50b, 51a, 51b, 51c, 51x, 52, 53, 500 Object
60 Moving body
80, 80em Box
82a, 82b, 82c, 82d, 82e, 82f, 82g, 82h, 82i, 82j, 82k, 82m Drawn line
100 Moving body positioning apparatus
120 Terminal apparatus
121 Map input unit
122 Positioning unit
123 Analysis unit
124 Drawing unit
200 Position/orientation information acquisition unit
201 Map information acquisition unit
202 Action analysis unit
203 Drawing information creation unit
204 Storage unit
510a, 510b, 510x, 520, 530, 540, 550 Area

1. An information processing apparatus comprising:
an acquisition unit that acquires at least a position and an orientation of a moving body; and
an analysis unit that generates a label indicating a motion of the moving body on a basis of the position and the orientation acquired by the acquisition unit and time when the acquisition unit acquired the position and the orientation.

2. The information processing apparatus according to claim 1, further comprising:
a generation unit that generates, on a basis of the label, visualization information including a visualization expression for visualizing the motion of the moving body.

3. The information processing apparatus according to claim 2, wherein
the generation unit generates the visualization information related to a change in the position of the moving body and the visualization information related to the orientation indicating a specific direction on a basis of the label.

4. The information processing apparatus according to claim 3, wherein
the generation unit generates the visualization information as the visualization expression of the orientation by displacing the visualization expression of the change in the position in a range of the orientation indicating the specific direction in the specific direction on a basis of the label.

5. The information processing apparatus according to claim 3, wherein
the generation unit generates the visualization information as the visualization expression of the orientation by emphasizing the visualization expression of the change in the position in a range of the orientation indicating the specific direction on a basis of the label.

6. The information processing apparatus according to claim 3, wherein
the generation unit generates the visualization information as the visualization expression of the orientation by indicating a start position and an end position of a range of the orientation indicating the specific direction in the visualization expression of the change in the position on a basis of the label.

7. The information processing apparatus according to claim 3, wherein
the generation unit
generates the visualization information for each unit obtained by dividing a two-dimensional plane in a predetermined manner, and
generates the visualization information as the visualization expression of the orientation by emphasizing a unit including the change in the position and a unit including a range of the orientation indicating the specific direction.

8. The information processing apparatus according to claim 3, wherein
the generation unit generates the visualization information in which, in a range of the orientation indicating the specific direction, the visualization expression of a portion of an object corresponding to the specific direction corresponding to the range is a visualization expression different from the visualization expression of another portion of the object on a basis of the label.

9. The information processing apparatus according to claim 1, wherein
the analysis unit acquires the orientation on a basis of a direction of an object associated with an area in which the motion of the moving body is defined on local coordinates defined in the area.

10. The information processing apparatus according to claim 9, wherein
the analysis unit acquires the orientation in units of divided regions obtained by dividing the local coordinates by a plurality of straight lines passing through an origin.

11. The information processing apparatus according to claim 1, wherein
the analysis unit generates the label according to a state of the moving body detected on a basis of at least one of the position, the orientation, and the time.

12. The information processing apparatus according to claim 11, wherein
the analysis unit generates the label on a basis of a velocity of the moving body.

13. The information processing apparatus according to claim 11, wherein
the analysis unit generates the label on a basis of the orientation of the moving body.

14. The information processing apparatus according to claim 11, wherein
the analysis unit generates the label on a basis of the position of the moving body.

15. The information processing apparatus according to claim 14, wherein
the analysis unit generates the label according to entering of the moving body into an area in which the motion of the moving body is defined on a basis of the position.

16. The information processing apparatus according to claim 1, wherein
the analysis unit generates the label on a basis of one or more motions designated according to a preset rule.

17. The information processing apparatus according to claim 1,
receiving the position and the orientation from a terminal apparatus associated with the moving body.

18. The information processing apparatus according to claim 1, further comprising:
a detection unit that detects the position and the orientation.

19. An information processing method executed by a processor, comprising:
an acquisition step of acquiring at least a position and an orientation of a moving body; and
an analysis step of generating a label indicating a motion of the moving body on a basis of the position and the orientation acquired by the acquisition step and time when the position and the orientation were acquired by the acquisition.

20. An information processing program for causing a computer to execute:
an acquisition step of acquiring at least a position and an orientation of a moving body; and
an analysis step of generating a label indicating a motion of the moving body on a basis of the position and the orientation acquired by the acquisition step and time when the position and the orientation were acquired by the acquisition.
